(19) United States
(12) Patent Application Publication
(10) Pub. No.: US 2021/0070175 A1
(43) Pub. Date: Mar. 11, 2021

(54) VEHICULAR DISPLAY CONTROL DEVICE AND VEHICULAR DISPLAY CONTROL METHOD

(71) Applicant: MITSUBISHI ELECTRIC CORPORATION, Tokyo (JP)

(72) Inventors: Mitsuo SHIMOTANI, Tokyo (JP); Yoshitaka NAKAMURA, Tokyo (JP)

(73) Assignee: MITSUBISHI ELECTRIC CORPORATION, Tokyo (JP)

(21) Appl. No.: 16/981,130

(22) PCT Filed: May 24, 2018
(86) PCT No.: PCT/JP2018/019989

§ 371 Date: Sep. 15, 2020

(51) Int. Cl. B60K 35/00; G02F 1/1335

(52) U.S. Cl. CPC B60K 35/00; B60K 2370/52; B60K 2370/31; G02F 1/133526

(57) ABSTRACT

In a display control unit, an information acquisition unit acquires first information and second information. A display processing unit causes a first display surface provided in a subject vehicle to display the first information, and causes a second display surface provided in the subject vehicle to display the second information. A lens control unit sets a virtual image distance of the first display surface by controlling a first liquid crystal lens arranged in front of the first display surface based on a type of the first information, and sets a virtual image distance of the second display surface by controlling a second liquid crystal lens arranged in front of the second display surface based on a type of the second information.

### TECHNICAL FIELD

The present invention relates to a vehicular display control device for displaying information on a display surface of a vehicle.

### BACKGROUND ART

Display control devices that display various information on a display surface provided in a vehicle have been known. For example, an instrument panel that is capable of displaying not only traveling speed and warnings but also vehicle operation information and route guidance information has already been commercialized. Further, as an alternative technique to conventional optical mirrors (side mirrors, rear-view mirrors, etc.), development of an electronic mirror system for displaying an image captured by a vehicle-mounted camera is also in progress.

Further, in Patent Document 1 below, a technique that realizes an easy-to-read display that appropriately corresponds to the traveling speed is proposed, in which the easy-to-read display is realized by arranging a liquid crystal lens in front of a meter displaying the traveling speed and the like, changing the refractive index of the liquid crystal lens in accordance with the traveling speed of the vehicle, and changing the apparent distance (sense of perspective) from the driver to the meter apparent through the liquid crystal lens.

### PRIOR ART DOCUMENTS

### Patent Documents

[Patent Document 1] Japanese Patent Application Laid-Open No. 2-302720

### SUMMARY

### Problem to be Solved by the Invention

The preferable set value of the apparent distance from a driver to a display surface of information differs depending on the type of information to be displayed. In the technique of Patent Document 1, the sense of perspective of the information display surface (meter) is uniformly adjusted in accordance with the traveling speed of the vehicle, and the type of information displayed is not considered.

The present invention has been made to solve the above problem, and an object of the present invention is to provide a vehicular display control device for controlling the sense of perspective of the display surface of information based on the type of the information.

### Means to Solve the Problem

According to the present invention, a vehicular display control device includes an information acquisition unit configured to acquire first information and second information, a display processing unit configured to cause a first display surface provided in a subject vehicle to display the first information, and cause a second display surface provided in the subject vehicle to display the second information, and a lens control unit configured to set a virtual image distance of the first display surface by controlling a first liquid crystal lens arranged in front of the first display surface based on a type of the first information, and set a virtual image distance of the second display surface by controlling a second liquid crystal lens arranged in front of the second display surface based on a type of the second information.

### Effects of the Invention

According to the present invention, the virtual image distance of the first information displayed on the first display surface is set based on the type of the first information, and the virtual image distance of the second information displayed on the second display surface is set based on the type of the second information. Therefore, setting the virtual image distance in accordance with the types of the first information and the second information is ensured.

The explicit purpose, feature, phase, and advantage of the present invention will be described in detail hereunder with attached drawings.

### BRIEF DESCRIPTION OF DRAWINGS

FIG. 1 A functional block diagram illustrating a configuration of a vehicular information display system according to Embodiment 1.

FIG. 2 A diagram for explaining a virtual image on a display surface.

FIG. 3 A front view of an instrument panel according to Embodiment 1.

FIG. 4 A diagram illustrating the configuration of the instrument panel according to Embodiment 1.

FIG. 5 A diagram illustrating an appearance of the instrument panel according to Embodiment 1.

FIG. 6 A table for explaining operation of a lens control unit according to Embodiment 1.

FIG. 7 A diagram for explaining operation of a display control device according to Embodiment 1.

FIG. 8 A diagram for explaining the operation of the display control device according to Embodiment 1.

FIG. 9 A diagram for explaining the operation of the display control device according to Embodiment 1.

FIG. 10 A flowchart illustrating the operation of the display control device according to Embodiment 1.

FIG. 11 A diagram for explaining Modification of Embodiment 1.

FIG. 12 A block diagram illustrating an example of a hardware configuration of the display control device.

FIG. 13 A block diagram illustrating an example of a hardware configuration of the display control device.

FIG. 14 A functional block diagram illustrating a configuration of a vehicular information display system according to Embodiment 2.

FIG. 15 A table for explaining operation of a lens control unit according to Embodiment 2.

FIG. 16 A flowchart illustrating the operation of the display control device according to Embodiment 2.

FIG. 17 A table for explaining Modification of Embodiment 2.

FIG. 18 A functional block diagram illustrating a configuration of a vehicular information display system according to Embodiment 3.

FIG. 19 A diagram for explaining operation of a display control device according to Embodiment 3.

FIG. 20 A diagram for explaining the operation of the display control device according to Embodiment 3.

FIG. 21 A diagram for explaining the operation of the display control device according to Embodiment 3.

FIG. 22 A diagram for explaining the operation of the display control device according to Embodiment 3.

FIG. 23 A flowchart illustrating the operation of the display control device according to Embodiment 3.

FIG. 24 A flowchart illustrating the operation of the display control device according to Embodiment 3.

FIG. 25 A diagram for explaining Modification of Embodiment 3.

FIG. 26 A diagram illustrating a configuration of an instrument panel according to Embodiment 4.

FIG. 27 A diagram illustrating an example of a rear transparent cover.

FIG. 28 A diagram illustrating an example of a front transparent cover.

FIG. 29 A diagram illustrating the configuration of the instrument panel according to Embodiment 4.

FIG. 30 A diagram for explaining a relationship between the distances from display surfaces to liquid crystal lenses and the virtual images of the display surfaces.

FIG. 31 A diagram for explaining Modification of Embodiment 4.

FIG. 32 A diagram for explaining Modification of Embodiment 4.

FIG. 33 A diagram for explaining Modification of Embodiment 4.

FIG. 34 A diagram for explaining Modification of Embodiment 4.

FIG. 35 A diagram for explaining Modification of Embodiment 4.

FIG. 36 A diagram for explaining Modification of Embodiment 4.

FIG. 37 A diagram for explaining Modification of Embodiment 4.

FIG. 38 A diagram for explaining Modification of Embodiment 4.

FIG. 39 A diagram for explaining Modification of Embodiment 4.

FIG. 40 A diagram for explaining Modification of Embodiment 4.

FIG. 41 A diagram for explaining Modification of Embodiment 4.

FIG. 42 A diagram for explaining a relationship between an inclination of the liquid crystal lens and a position of the virtual image of the display surface.

FIG. 43 A diagram for explaining a relationship between an inclination of the liquid crystal lens, and a position of the virtual image of the display surface.

FIG. 44 A diagram illustrating an example of an instrument panel and two transparent covers according to Embodiment 5.

FIG. 45 A diagram illustrating an example of a display change of the instrument panel according to Embodiment 5.

FIG. 46 A diagram for explaining Modification of Embodiment 5.

FIG. 47 A diagram for explaining Modification of Embodiment 5.

### DESCRIPTION OF EMBODIMENTS

### Embodiment 1

FIG. 1 is a functional block diagram illustrating a configuration of a vehicular information display system according to Embodiment 1. In the following description, a vehicle equipped with the vehicular information display system is referred to as “subject vehicle”. As illustrated in FIG. 1, the vehicular information display system includes a vehicular display control device 10 (hereinafter, simply referred to as “display control device 10”), a first display surface 21, a second display surface 22, a first liquid crystal lens 31, a second liquid crystal lens 32, an in-vehicle Local Area Network (LAN) 41, and an image capturing device 42 connected to the display control device 10.

The in-vehicle LAN 41 is a communication network built in the subject vehicle. On the in-vehicle LAN 41, communication is implemented among on-vehicle devices, by the Controller Area Network (CAN), for information that indicates the traveling state of the vehicle such as the traveling speed of the subject vehicle and control signals that control the travel of the vehicle.

The image capturing device 42 is a camera mounted on the subject vehicle and captures an image for an electronic mirror. Here, it is assumed that the image capturing device 42 captures a landscape behind the subject vehicle, which corresponds to a range seen by a driver through the rear-view mirror of the subject vehicle. Hereinafter, an image of the landscape behind the subject vehicle captured by the image capturing device 42 is referred to as a “rear image”.

The first display surface 21 and the second display surface 22 are for the display control device 10 to display information. The first display surface 21 and the second display surface 22 are not limited to image display devices such as a liquid crystal display panel, and include, for example, mechanical meters that display information on the traveling state of the subject vehicle such as traveling speed and engine speed.

The first liquid crystal lens 31 and the second liquid crystal lens 32 are configured by sealing liquid crystal between lens-shaped transparent electrodes, and can change the refractive index by applying a voltage between the transparent electrodes. The first liquid crystal lens 31 is arranged in front of the first display surface 21, and the second liquid crystal lens 32 is arranged in front of the second display surface 22. Therefore, the driver of the subject vehicle sees the first display surface 21 through the first liquid crystal lens 31, and sees the second display surface 22 through the second liquid crystal lens 32.

When the refractive indexes of the first liquid crystal lens 31 and the second liquid crystal lens 32 change, their focal lengths change. Therefore, the first liquid crystal lens 31 can change the apparent distance from the driver to the first display surface 21, and the second liquid crystal lens 32 can change the apparent distance from the driver to the second display surface 22. Hereinafter, the image of the display surface seen through the liquid crystal lens is referred to as a “virtual image” of the display surface, and the apparent distance from the observer (driver) to the display surface is referred to as a “virtual image distance”.

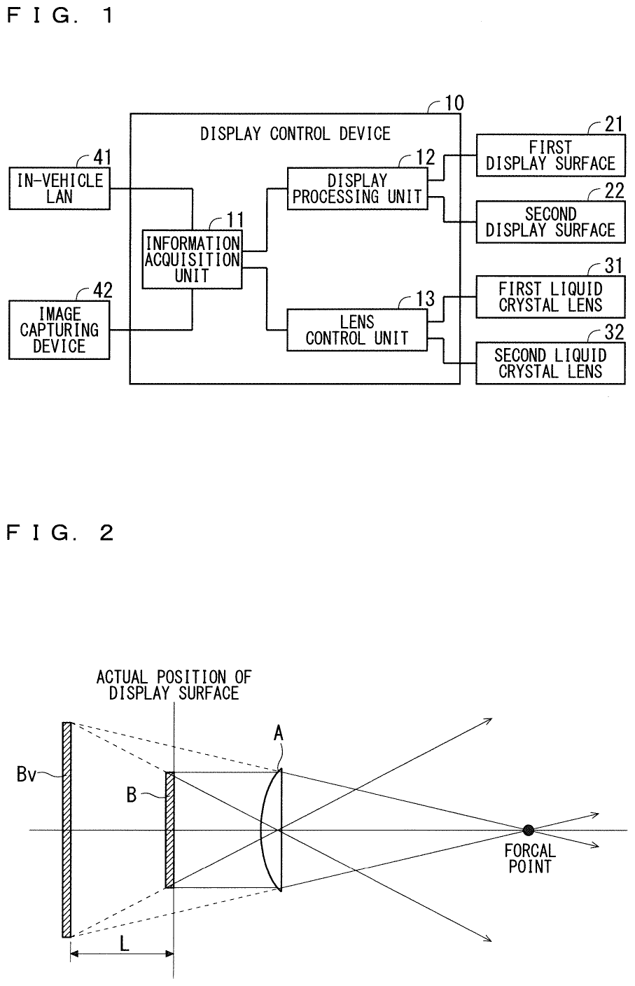

The virtual image of the display surface will be described with reference to FIG. 2. As illustrated in FIG. 2, when a convex lens type liquid crystal lens A is arranged in front of a display surface B, and when the liquid crystal lens A is in the off state, the liquid crystal lens A does not function as a lens and the display surface B appears as it is to an observer. Meanwhile, when the liquid crystal lens A is turned to the on state, the display surface B appears to the observer as a virtual image By located further from the actual position by a distance L. That is, when the liquid crystal lens A is on, the virtual image distance of the display surface B is increased by L than when it is off. Further, as can be seen from FIG. 2, the virtual image By of the display surface B appears slightly larger than the actual display surface B.

In the following description, the first liquid crystal lens 31 and the second liquid crystal lens 32 are convex lenses, unless otherwise specified. However, the first liquid crystal lens 31 and the second liquid crystal lens 32 are not limited to convex lenses, and may be concave lenses as long as a desired virtual image distance can be secured.

The display control device 10 acquires a traveling speed of the subject vehicle from the in-vehicle LAN 41 as first information and causes the first display surface 21 to display the information. Further, the display control device 10 acquires an image for an electronic mirror (a rear image of the subject vehicle) captured by the image capturing device 42 as second information and causes the second display surface 22 to display the information. Here, in Embodiment 1, the first display surface 21 is a mechanical meter that displays the traveling speed of the subject vehicle, and the second display surface 22 is an image display device (for example, a liquid crystal display panel or the like) that displays a rear image.

Further, the display control device 10 controls the first liquid crystal lens 31 and the second liquid crystal lens 32 to control the virtual image distance of the first display surface 21 and the virtual image distance of the second display surface 22. At that time, the display control device 10 sets the virtual image distance of the first display surface 21 based on the type of the first information to be displayed on the first display surface 21 and the virtual image distance of the first display surface 21 based on the type of the second information to be displayed on the second display surface 22. Here, the type of the first information is the traveling speed of the subject vehicle, and the type of the second information is an image for the electronic mirror. Therefore, the display control device 10 sets the virtual image distance of the first display surface 21 to a value suitable for displaying the traveling speed of the subject vehicle, and sets the virtual image distance of the second display surface 22 to a value suitable for displaying the image for the electronic mirror.

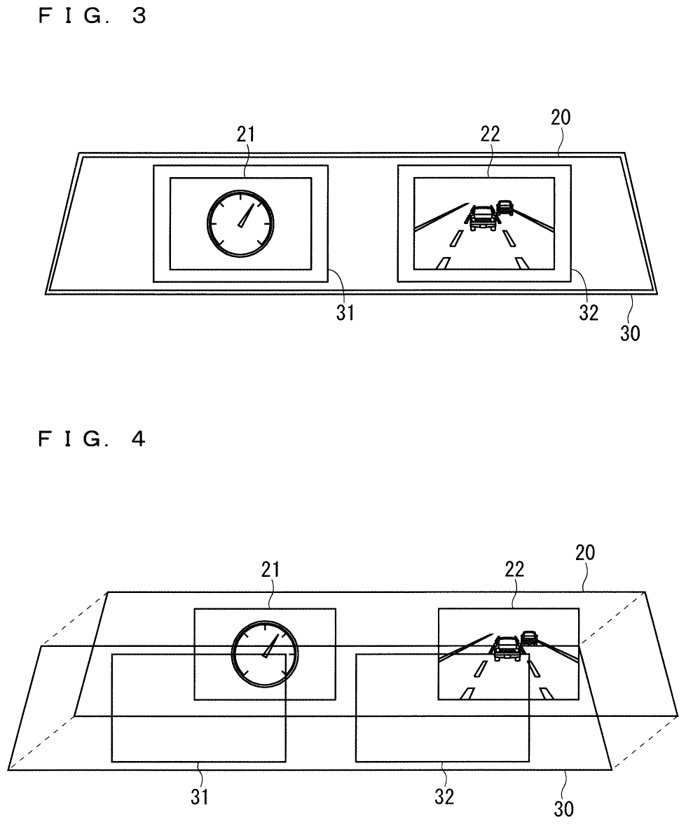

In Embodiment 1, the first display surface 21 and the second display surface 22 are assumed to be arranged inside an instrument panel of the subject vehicle. FIG. 3 is a front view of the instrument panel including the first display surface 21 and the second display surface 22.

The first display surface 21 and the second display surface 22 are arranged on a display plate 20 of the instrument panel. The first liquid crystal lens 31 and the second liquid crystal lens 32 are provided on a transparent cover 30 installed in front of the display plate 20. As illustrated in FIG. 3, the first liquid crystal lens 31 is arranged so as to overlap the first display surface 21 when viewed from the driver, and the second liquid crystal lens 32 is arranged so as to overlap the second display surface 22 when viewed from the driver.

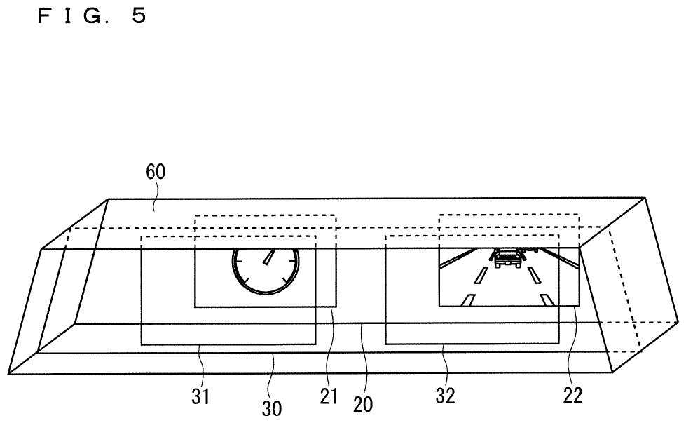

FIG. 4 illustrates the positional relationship between the display plate 20 and the transparent cover 30 of the instrument panel. As illustrated in FIG. 4, a certain distance is provided between the display plate 20 on which the first display surface 21 and the second display surface 22 are arranged and the transparent cover 30 on which the first liquid crystal lens 31 and the second liquid crystal lens 32 are arranged. When the instrument panel is installed in the subject vehicle, the display plate 20 and the transparent cover 30 are housed in a housing 60 as illustrated in FIG. 5.

Returning to FIG. 1, the display control device 10 includes an information acquisition unit 11, a display processing unit 12, and a lens control unit 13.

The information acquisition unit 11 acquires the traveling speed of the subject vehicle from the in-vehicle LAN 41 as the first information, and acquires the rear image of the subject vehicle from the image capturing device 42 as the second information. The display processing unit 12 causes the first display surface 21 to display the first information acquired by the information acquisition unit 11, and causes the second display surface 22 to display the second information acquired by the information acquisition unit 11.

The lens control unit 13 sets the virtual image distance of the first display surface 21 by controlling the first liquid crystal lens 31 based on the type of the first information, and sets the virtual image distance of the second display surface 22 by controlling the second liquid crystal lens 32 based on the type of the second information. That is, the lens control unit 13 controls the sense of perspective of the first display surface 21 and the second display surface 22 based on the types of the first information and the second information.

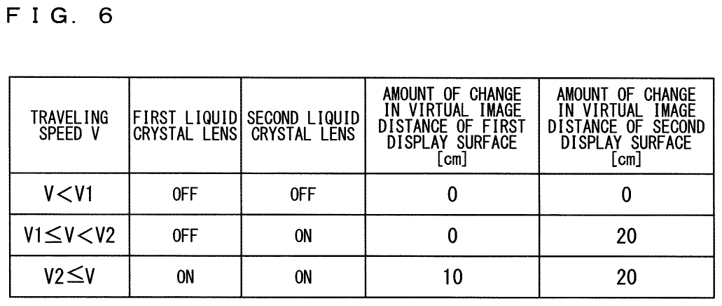

FIG. 6 illustrates the operation of the lens control unit 13 according to Embodiment 1. As illustrated in FIG. 6, the lens control unit 13 controls the first liquid crystal lens 31 that changes the virtual image distance of the first display surface 21, and the second liquid crystal lens 32 that changes the virtual image distance of the second display surface 22 by different methods respectively. Specifically, when the traveling speed V of the subject vehicle is smaller than a predetermined first threshold V1 (for example, 40 km/h), the lens control unit 13 turns off both the first liquid crystal lens 31 and the second liquid crystal lens 32, whereas when the traveling speed V of the subject vehicle reaches the first threshold value V1, the lens control unit 13 turns on the second liquid crystal lens 32, and when the traveling speed V further increases and reaches to a second threshold value V2 (for example, 80 km/h), the lens control unit 13 turns on the first liquid crystal lens 31.

Further, when the first liquid crystal lens 31 is turned on, the amount of change in the virtual image distance of the first display surface 21 (corresponding to the distance L in FIG. 2) is 10 cm, while when the second liquid crystal lens 32 is turned on, the amount of change in the virtual image distance of the second display surface 22 is 20 cm. Therefore, when the traveling speed V is equal to or higher than the first threshold value V1, the virtual image distance of the second display surface 22 is longer than the virtual image distance of the first display surface 21.

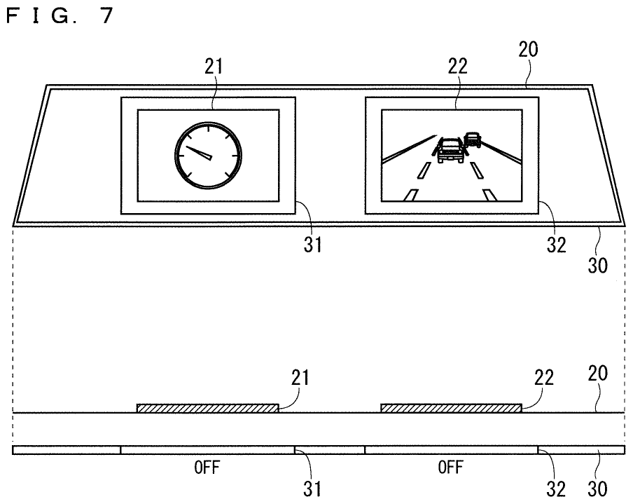

The appearance of the first display surface 21 and the second display surface 22 in this case will be described with reference to FIGS. 7 to 9. The upper parts of FIGS. 7 to 9 illustrate the state when the instrument panel is viewed from the front side, and the positions of the virtual images of the first display surface 21 and the second display surface 22 are schematically illustrated in plan view in the lower portions of FIGS. 7 to 9.

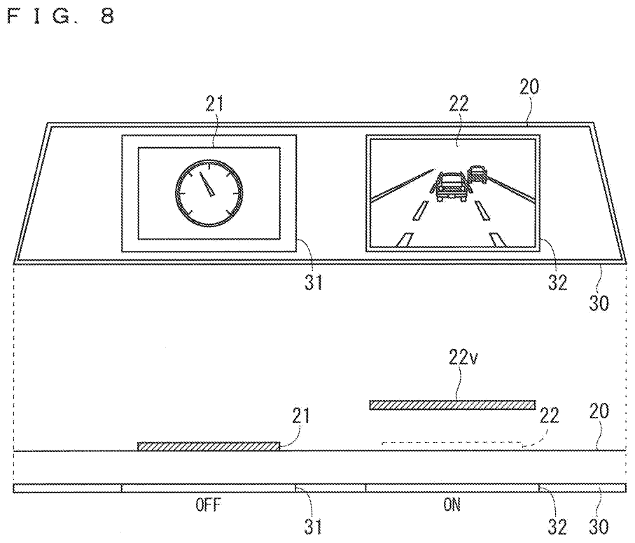

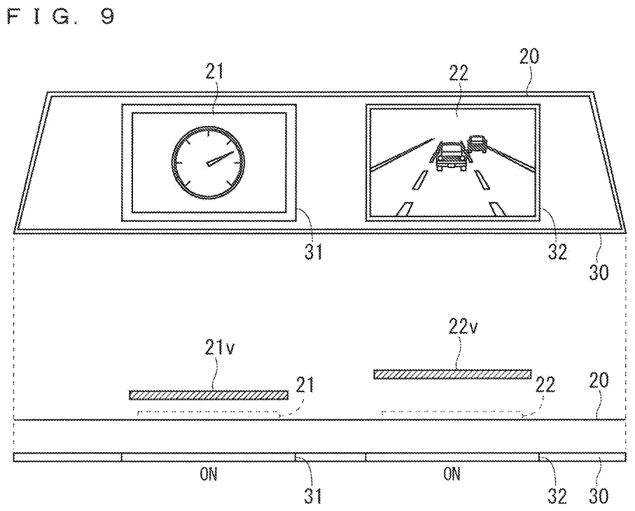

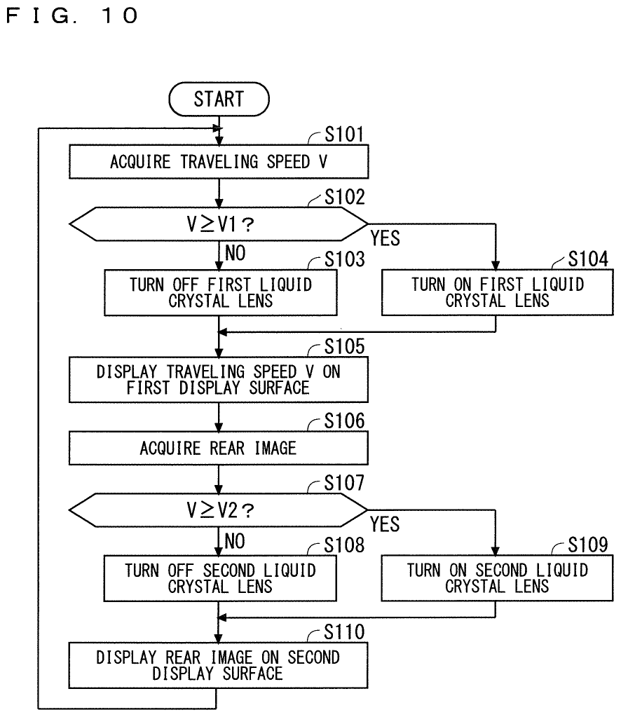

In Embodiment 1, when the traveling speed V of the subject vehicle is smaller than the first threshold value V1, the first display surface 21 and the second display surface 22 appear at the actual positions on the display plate 20, as illustrated in FIG. 7. However, when the traveling speed V reaches the first threshold value V1, the virtual image 22v of the second display surface 22 appears 20 cm farther from the actual position on the display plate 20, as illustrated in FIG. 8. Further, when the traveling speed V reaches the second threshold value V2, the virtual image 21v of the first display surface 21 appears 10 cm farther from the actual position on the display plate 20, as illustrated in FIG. 9.

When the traveling speed of the vehicle increases, the driver tends to look far ahead. Therefore, the virtual image distances of the first display surface 21 and the second display surface 22 are increased when the traveling speed V of the subject vehicle increases, so that the virtual images of the first display surface 21 and the second display surface 22 appear at the positions which are readily viewed by the driver.

The rear image displayed on the second display surface 22 is an image of the outside of the subject vehicle. Therefore, by making the virtual image distance of the second display surface 22 longer than the virtual image distance of the first display surface 21, which is a mechanical meter, a sense of discomfort the driver has when looking at the first display surface 21 and the second display surface 22 can be alleviated.

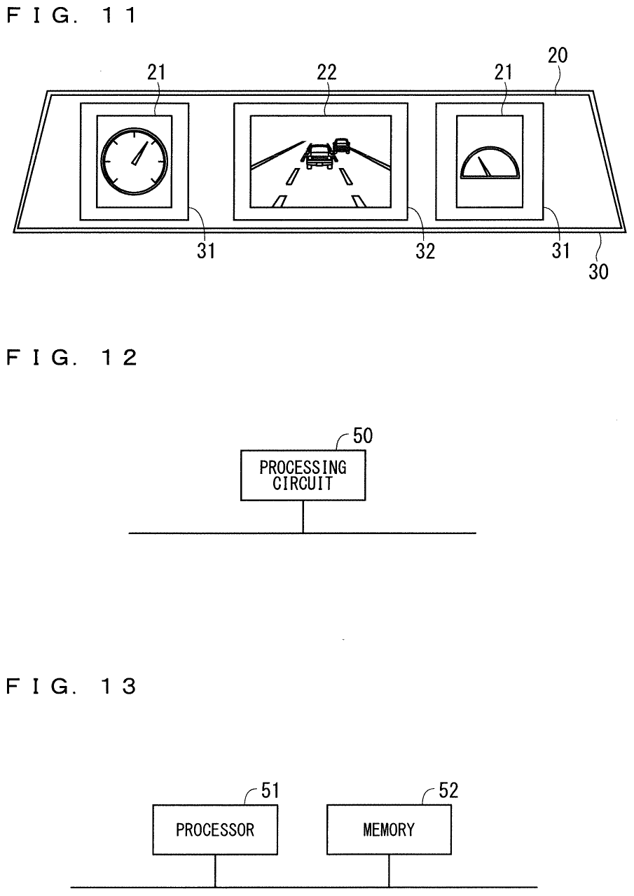

FIG. 10 is a flowchart illustrating the operation of the display control device 10 according to Embodiment 1. Hereinafter, the operation of the display control device 10 according to Embodiment 1 will be described with reference to FIG. 10.

When the display control device 10 is activated, the information acquisition unit 11 acquires the traveling speed V of the subject vehicle from the in-vehicle LAN 41 (Step S101). Then, the lens control unit 13 checks whether the traveling speed V is equal to or higher than the first threshold value V1 (Step S102). When the traveling speed V is less than the first threshold value V1 (NO in Step S102), the lens control unit 13 turns off the first liquid crystal lens 31 (Step S103). When the traveling speed V is equal to or higher than the first threshold value V1 (YES in Step S102), the lens control unit 13 turns on the first liquid crystal lens 31 (Step S104). Then, the display processing unit 12 causes the first display surface 21 to display the traveling speed V (Step S105).

Then, the information acquisition unit 11 acquires the rear image of the subject vehicle from the image capturing device 42 as an image for the electronic mirror (Step S106). Then, the lens control unit 13 checks whether the traveling speed V is equal to or higher than the second threshold value V2 (Step S107). When the traveling speed V is less than the second threshold value V2 (NO in Step S107), the lens control unit 13 turns off the second liquid crystal lens 32 (Step S108). When the traveling speed V is equal to or higher than the second threshold value V2 (YES in Step S107), the lens control unit 13 turns on the second liquid crystal lens 32 (Step S109). Then, the display processing unit 12 causes the second display surface 22 to display the rear image of the subject vehicle (Step S110).

The above flow is repeatedly executed. Accordingly, the operation of the display control device 10 described with reference to FIGS. 7 to 9 is realized.

[Modification]

Although the first display surface 21 is a mechanical meter in Embodiment 1, the first display surface 21 may be an image display device that displays an image of a meter (for example, a liquid crystal display panel). When both the first display surface 21 and the second display surface 22 are configured by image display devices, the first display surface 21 and the second display surface 22 may not be separated image display devices, respectively. Alternatively, the first display surface 21 and the second display surface 22 may be different areas defined on the screen of one image display device. For example, in one horizontally long screen, the left half area may be the first display surface 21, and the right half area may be the second display surface 22.

Further, in Embodiment 1, although an example is illustrated in which the on/off of the first liquid crystal lens 31 and the second liquid crystal lens 32 is controlled based on the traveling speed of the subject vehicle, other conditions indicating the traveling state of the subject vehicle may be adopted. For example, the information acquisition unit 11 may acquire information on the classification of the road on which the vehicle is traveling (highway, general road, urban area, residential area, mountainous area, etc.) from the navigation system (not illustrated) of the subject vehicle, and the lens control unit 13 may control the on/off of the liquid crystal lenses based on the information. For example, the second liquid crystal lens 32 may be turned on to increase the virtual image distance of the second display surface 22 on a highway where the traveling speed of the subject vehicle is expected to increase, and the second liquid crystal lens 32 may be turned off on other roads.

Further, in Embodiment 1, although the optical characteristics of the first liquid crystal lens 31 and the second liquid crystal lens 32 are two types of ON state and OFF state, the focal lengths may be changed continuously or in a multiple-step manner by changing the voltage applied to the first liquid crystal lens 31 and the second liquid crystal lens 32 continuously or in a multiple-step manner. For example, a voltage proportional to the traveling speed of the subject vehicle may be applied to the second liquid crystal lens 32 so that the virtual image distance of the second display surface 22 increases as the traveling speed increases.

The shapes of the first liquid crystal lens 31 and the second liquid crystal lens 32 may be different from one another. For example, in a case where the area of the first display surface 21 is larger than the area of the second display surface 22, the first liquid crystal lens 31 may be larger than the second liquid crystal lens 32. Also, the shapes of the first liquid crystal lens 31 and the second liquid crystal lens 32 are not limited to rectangle, and may be any shape (for example, a circle or a polygon) according to the shapes of the first display surface 21 and the second display surface 22.

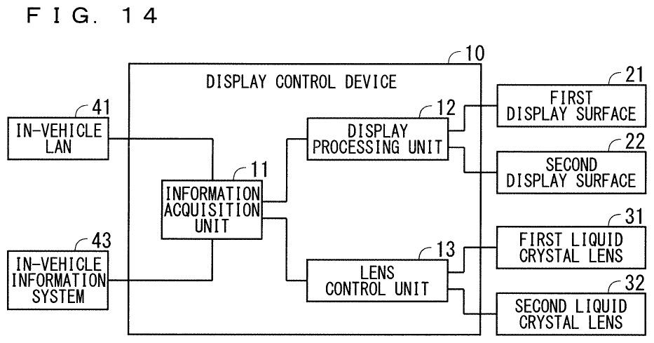

Further, in Embodiment 1, although the number of provided first liquid crystal lens 31 and the second liquid crystal lens 32 is one respectively, a plurality of each may be provided. For example, as illustrated in FIG. 11, when the meters as the first display surfaces 21 are arranged in two places of the display plate 20 of the instrument panel, the first liquid crystal lenses 31 may also be provided in two places as well.

Further, in Embodiment 1, although an example in which the two display surfaces (the first display surface 21 and the second display surface 22) are arranged on the display plate 20 of the instrument panel has been illustrated, when the display plate 20 has three or more display surfaces, three or more liquid crystal lenses may be provided so as to overlap each display surface, and the display control device 10 may control the three or more liquid crystal lenses. For example, in addition to the first display surface 21 and the second display surface 22 illustrated in FIG. 3 and the like, a third display surface corresponding to the indicating lamps and the warning lamps of the subject vehicle may be arranged on the display plate 20, and a third liquid crystal lens may be provided in a portion corresponding to the third display surface in the transparent cover 30.

Further, the number of devices of which information is to be input to the display control device 10 is not limited to two, and may be three or more. For example, the display control device 10 may acquire information from indicating lamps, warning lamps, a traveling control system with automatic driving function, a surrounding state detection device (sensor, radar, etc.), an in-vehicle image capturing device, (a camera for electronic mirror, a front camera, a rear camera, an infrared camera, etc.) of the vehicle, display the acquired information using three or more display surfaces, and control the virtual image distance of each display surface using the liquid crystal lenses. Also, the display control device 10 may cause the first display surface 21 or the second display surface 22 to display information acquired from a device brought into the subject vehicle such as a cellular phone or a smart phone.

Further, in FIG. 1, although the first display surface 21 and the second display surface 22 are configured to be externally connected to the display control device 10, the display control device 10 may have a built-in display device including the first display surface 21 and the second display surface 22.

[Example of Hardware Configuration]

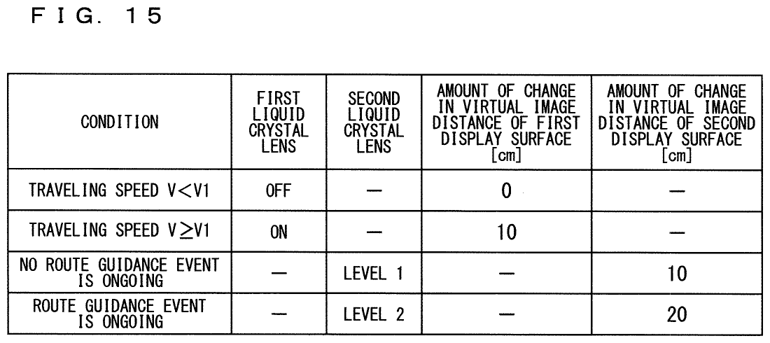

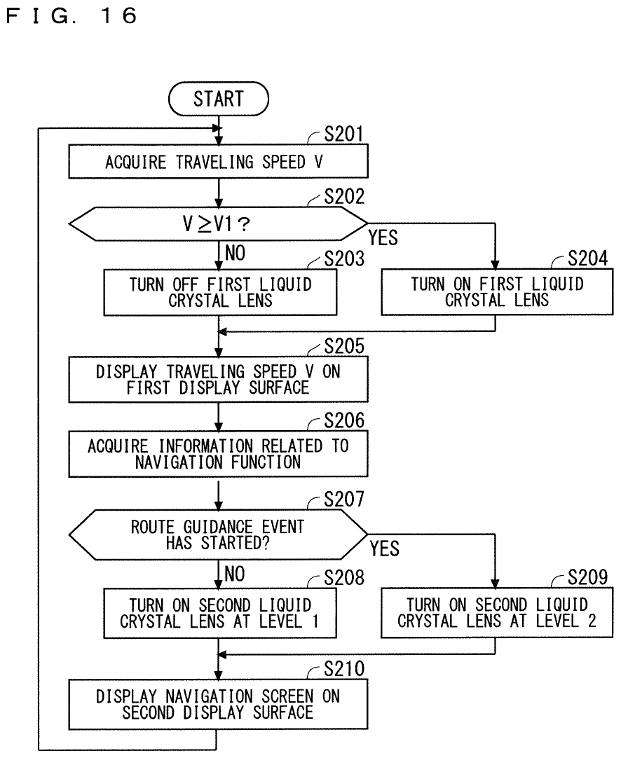

FIGS. 12 and 13 are block diagrams each illustrating an example of a hardware configuration of the display control device 10. Each function of the components (the information acquisition unit 11, the display processing unit 12, and the lens control unit 13) of the display control device 10 illustrated in FIG. 1 is realized by the processing circuit 50 illustrated in FIG. 12, for example. That is, the display control device 10 includes a processing circuit 50 for acquiring the first information and the second information, causing the first display surface provided in the subject vehicle to display the first information, causing the second display surface provided in the subject vehicle to display the second information, setting the virtual image distance of the first display surface by controlling the first liquid crystal lens arranged in front of the first display surface based on the type of the first information, and setting the virtual image distance of the second display surface by controlling the second liquid crystal lens arranged in front of the second display surface based on the type of the second information. The processing circuit 50 may be dedicated hardware, or may be configured by a processor that executes a program stored in a memory (also referred to as a Central Processing Unit (CPU), a processing device, an arithmetic device, a microprocessor, a microcomputer, or a Digital Signal Processor (DSP)).

When the dedicated hardware is applied to the processing circuit 50, the processing circuit 50 corresponds to a single circuit, a composite circuit, a programmed processor, a parallel programmed processor, an Application Specific Integrated Circuit (ASIC), or a Field-Programmable Gate Array (FPGA), or the combination thereof. Each function of the components of the display control device 10 may be realized by an individual processing circuit, or the functions may be collectively realized by one processing circuit.

FIG. 13 illustrates an example of a hardware configuration of the display control device 10 when the processing circuit 50 is configured using a processor 51 that executes a program. The functions of the components of the display control device 10 are realized by software (software, firmware, or a combination of software and firmware) or the like. The software or the like is described as a program and stored in a memory 52. The processing circuit 51 reads out and executes the program stored in the memory 52, thereby realizing the function of each unit. That is, the display control device 10 includes a memory 52 for storing the programs which, eventually, executes a process of acquiring the first information and the second information, a process of causing the first display surface provided in the subject vehicle to display the first information, and causing the second display surface provided in the subject vehicle to display the second information, a process of setting the virtual image distance of the first display surface by controlling the first liquid crystal lens arranged in front of the first display surface based on the type of the first information, and setting the virtual image distance of the second display surface by controlling the second liquid crystal lens arranged in front of the second display surface based on the type of the second information, when it is executed by the processor 51. In other words, it can be said that the program causes the computer to execute procedures and methods of the operation of the components of the display control device 10.

Here, the memory 52 may be, for example, a non-volatile or volatile semiconductor memory, such as a Random Access Memory (RAM), a Read Only Memory (ROM), a flash memory, an Erasable Programmable Read Only Memory (EPROM), an Electrically Erasable Programmable Read Only Memory (EEPROM), or the like, a Hard Disk Drive (HDD), a magnetic disk, a flexible disk, an optical disk, a compact disk, a mini disk, a Digital Versatile Disc (DVD) and a drive device therefor, or any storage medium used in the future.

The configuration has been described thus far, in which the functions of the components of the display control device 10 are realized by hardware, software, or the like. However, the present invention is not limited thereto, and a configuration in which part of the components of the display control device 10 is realized by dedicated hardware and another part of the components is realized by software or the like. For example, the functions of the part of the components can be realized by the processing circuit 50 as dedicated hardware, and the functions of the other part of the components can be realized by the processing circuit 50 as the processor 51 reading out and executing the program stored in the memory 52.

As described above, the display control device 10 can realize the functions described above by hardware, software, or the like, or a combination thereof.

### Embodiment 2

FIG. 14 is a functional block diagram illustrating a configuration of a vehicular information display system according to Embodiment 2. The vehicular information display system in FIG. 14 has a configuration in which the image capturing device 42 connected to the display control device 10 in the configuration of FIG. 1 is replaced with an in-vehicle information system 43.

The display control device 10 acquires information output by the in-vehicle information system 43 and causes the second display surface 22 to display the information. Here, the in-vehicle information system 43 has a navigation function, and the display control device 10 causes the second display surface 22 to display a screen (navigation screen) related to the navigation function of the in-vehicle information system 43. The navigation screen includes, for example, a map screen (including a display of the current position of the subject vehicle and a scheduled travel route) displayed when no route guidance event is ongoing, and a guidance screen (screen for guiding the road the subject vehicle should travel to) displayed when the route guidance event is ongoing, are included. It should be noted that the route guidance event starts when the subject vehicle approaches a point where route guidance by the in-vehicle information system 43 is performed.

Further, in Embodiment 2, the second liquid crystal lens 32 arranged in front of the second display surface 22 is assumed to have a plurality of optical characteristics. That is, the lens control unit 13 can change the virtual image distance of the second display surface 22 in a multiple-step manner by changing the voltage applied to the second liquid crystal lens 32. Here, when the second liquid crystal lens 32 is turned on, the lens control unit 13 can select either “level 1”, that makes the position of the virtual image on the second display surface 22 away from the actual position by 10 cm, or “level 2” that makes the position of the virtual image on the second display surface 22 away from the actual position by 20 cm.

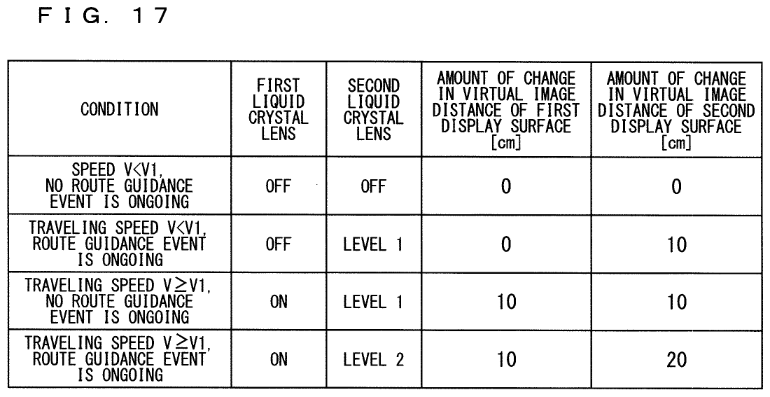

FIG. 15 illustrates the operation of the lens control unit 13 according to Embodiment 2. As illustrated in FIG. 15, the lens control unit 13 controls the first liquid crystal lens 31 that changes the virtual image distance of the first display surface 21, and the second liquid crystal lens 32 that changes the virtual image distance of the second display surface 22 by different methods respectively. That is, the lens control unit 13 controls the first liquid crystal lens 31 based on the traveling speed of the subject vehicle, and controls the second liquid crystal lens 32 based on whether or not the route guidance event is ongoing.

Specifically, the lens control unit 13 turns off the first liquid crystal lens 31 when the traveling speed V of the subject vehicle is smaller than a predetermined threshold V1 (for example, 40 km/h), and turns on the first liquid crystal lens 31 when the traveling speed V reaches the threshold V1 or higher. Also, the lens control unit 13 turns on the second liquid crystal lens 32 at level 1 when no route guidance event is ongoing, and turns on the second liquid crystal lens 32 at level 2 when the route guidance event is ongoing.

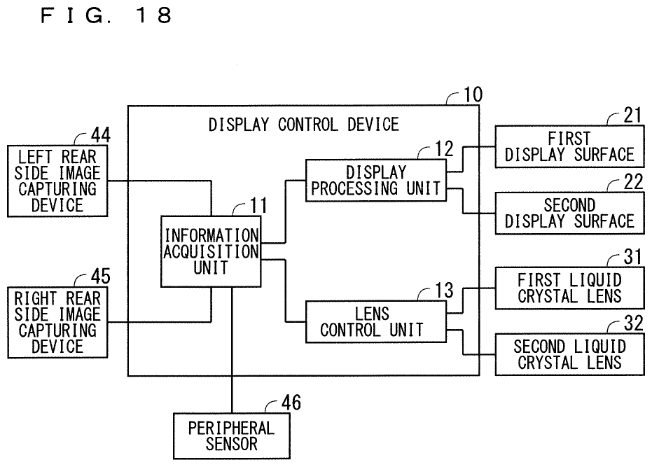

FIG. 16 is a flowchart illustrating the operation of the display control device 10 according to Embodiment 2. Hereinafter, the operation of the display control device 10 according to Embodiment 2 will be described with reference to FIG. 16.

When the display control device 10 is activated, the information acquisition unit 11 acquires the traveling speed V of the subject vehicle from the in-vehicle LAN 41 (Step S201). Then, the lens control unit 13 checks whether the traveling speed V is equal to or higher than the threshold value V1 (Step S202). When the traveling speed V is less than the threshold value V1 (NO in Step S202), the lens control unit 13 turns off the first liquid crystal lens 31 (Step S203). When the traveling speed V is equal to or higher than the threshold value V1 (YES in Step S202), the lens control unit 13 turns on the first liquid crystal lens 31 (Step S204). Then, the display processing unit 12 causes the first display surface 21 to display the traveling speed V (Step S205).

Subsequently, the information acquisition unit 11 acquires information related to the navigation function (for example, information on a map around the subject vehicle and information on route guidance) from the in-vehicle information system 43 (Step S206). Then, the lens control unit 13 checks whether or not the route guidance event is ongoing (Step S207). When no route guidance event is ongoing (NO in Step S207), the lens control unit 13 turns on the second liquid crystal lens 32 at level 1 (Step S208). When a route guidance event is ongoing (YES in Step S207), the lens control unit 13 turns on the second liquid crystal lens 32 at level 2 (Step S209). Then, the display processing unit 12 causes the second display surface 22 to display the navigation screen indicating the information acquired in Step S206 (Step S210). The navigation screen displayed on the second display surface 22 in Step S210 is a map screen when no route guidance event is ongoing, and is a guidance screen when a route guidance event is ongoing.

The above flow is repeatedly executed. Accordingly, the operation of the display control device 10 corresponding to FIG. 15 is realized.

According to the vehicular information display system according to Embodiment 2, when the route guidance event is ongoing, the viewpoint movement when seeing the guidance screen displayed on the second display surface 22 from the state where the driver is looking ahead is reduced, and accordingly, a guidance screen that is readily viewed by the driver can be realized. Further, by changing the virtual image distance of the second display surface 22 when a route guidance event is ongoing, it is readily recognized that which information the driver should check.

[Modification]

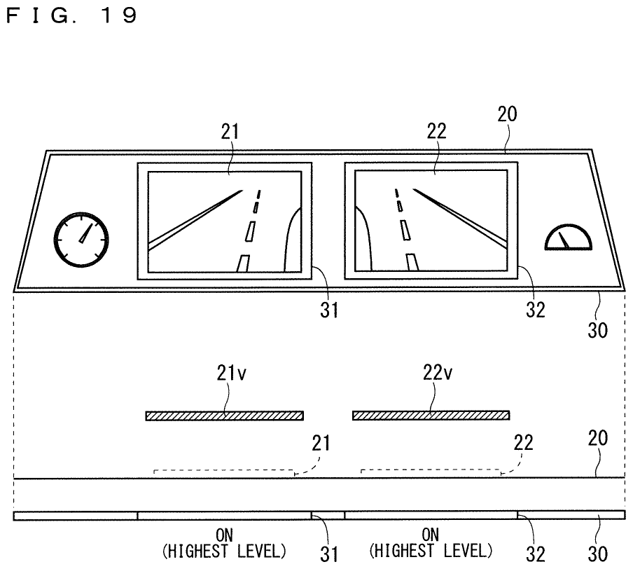

In the example of FIG. 15, although the virtual image distance of the second display surface 22 on which the navigation screen is displayed does not depend on the traveling speed of the subject vehicle, for example, as illustrated in FIG. 17, the virtual image distance may be changed in accordance with the traveling speed of the subject vehicle. In the example of FIG. 17, the second liquid crystal lens 32 is turned off when the traveling speed V of the subject vehicle is less than the threshold value V1 and no route guidance event is ongoing.

Also, when the route guidance event starts, the lens control unit 13 may control the second liquid crystal lens 32 so that the virtual image distance of the second display surface 22 changes based on a predetermined function. When LS represents the virtual image distance of the second display surface 22 before the route guidance event starts and LE represents the virtual image distance of the second display surface 22 after the route guidance event starts, for example, the virtual image distance of the display surface 22 may be changed from LS to LE continuously or in a multiple-step manner when the route guidance event starts. Further, the virtual image distance of the second display surface 22 may vibrate between LS and LE for a certain period immediately after the route guidance event starts (for example, for 2 seconds).

The specific event that becomes the trigger for changing the virtual image distance of the second display surface 22 is not limited to the route guidance event, and for example, a notification event of traffic congestion information or disaster information, or a notification event of notifying the presence of a branch road or a merging path may be adoptable.

Further, the display processing unit 12 may not cause the second display surface 22 to display all the information acquired from the in-vehicle information system 43, but selects the information to be displayed so that the content of the ongoing event is displayed briefly. For example, when a route guidance event starts, the display processing unit 12 may erase the display of the map from the second display surface 22 and display only the arrow indicating the direction of the route guidance on the second display surface 22. In this case, it is preferable that a display device dedicated to the in-vehicle information system 43 is provided in the subject vehicle separately from the second display surface 22 so that the driver can check the map. Alternatively, a third display surface for briefly displaying the content of the event and a third liquid crystal lens for controlling the virtual image distance may be provided.

The screen that the display control device 10 acquires from the in-vehicle information system 43 and causes to be displayed on the second display surface 22 is not limited to the navigation screen, and may be, for example, a screen that displays the automatic driving level. In this case, a notification event of changing the automatic driving level may be adopted as a trigger for changing the virtual image distance of the second display surface 22.

Further, the specific event that serves as a trigger for changing the virtual image distance of the second display surface 22 may be an event that occurs in a device other than the in-vehicle information system 43. For example, a specific event that occurs in indicating lamps, warning lamps, a traveling control system with automatic driving function, a surrounding state detection device (sensor, radar, etc.), an in-vehicle image capturing device, (a camera for electronic mirror, a front camera, a rear camera, an infrared camera, etc.), may be used as a trigger.

### Embodiment 3

FIG. 18 is a functional block diagram illustrating a configuration of a vehicular information display system according to Embodiment 3. The vehicular information display system in FIG. 18 has a configuration in which the in-vehicle LAN 41 and the image capturing device 42 connected to the display control device 10 in the configuration of FIG. 1 are replaced with a left rear side image capturing device 44 and a right rear side image capturing device 45, respectively, and a peripheral sensor 46 is further connected to the display control device 10.

The left rear side image capturing device 44 captures, as the first image for the electronic mirror, an image of a landscape on a left rear side of the subject vehicle, which corresponds to a range seen by the driver through the left side mirror of the subject vehicle. Hereinafter, an image captured by the left rear side image capturing device 44 is referred to as a “left rear side image”.

The right rear side image capturing device 45 captures, as the second image for the electronic mirror, an image of a landscape on a right rear side of the subject vehicle, which corresponds to a range seen by the driver through the right side mirror of the subject vehicle. Hereinafter, an image captured by the right rear side image capturing device 45 is referred to as a “right rear side image”.

The peripheral sensor 46 detects an object existing around the subject vehicle, and measures the relative position of the object with respect to the subject vehicle and the distance from the subject vehicle to the object. The peripheral sensor 46 needs only detect an object in at least the image capturing ranges of the left rear side image capturing device 44 and the right rear side image capturing device 45, that is, the ranges captured in the left rear side image and the right rear side image. The peripheral sensor 46 transmits information on the distance from the vehicle to the object captured in the left rear side image or the right rear side image to the display control device 10. Here, the object detected by the peripheral sensor 46 is assumed to be another vehicle captured in the left rear side image or the right rear side image.

In the display control device 10, the information acquisition unit 11 acquires the left rear side image captured by the left rear side image capturing device 44, the right rear side image captured by the right rear side image capturing device 45, and the information on the distance to the object detected by the peripheral sensor 46. The display processing unit 12 causes the first display surface 21 to display the left rear side image, and causes the second display surface 22 to display the right rear side image. Further, the lens control unit 13 controls the first liquid crystal lens 31 based on the distance from the subject vehicle to the other vehicle captured in the left rear side image, and controls the second liquid crystal lens 32 based on the distance from the subject vehicle to the other vehicle captured in the right rear side image.

For example, as illustrated in FIG. 19, when the other vehicle is not captured in the left rear side image displayed on the first display surface 21 and the right rear side image displayed on the second display surface 22, the lens control unit 13 turns on the first liquid crystal lens 31 and the second liquid crystal lens 32 at the highest level. As a result, the apparent distances from the driver to the virtual image 21v of the first display surface 21 and the virtual image 22v of the second display surface 22, that is, the virtual image distances of the first display surface 21 and the second display surface 22 are maximized.

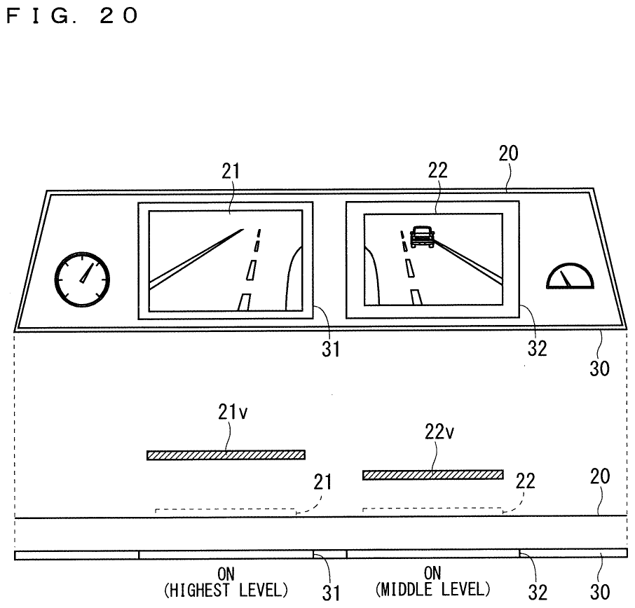

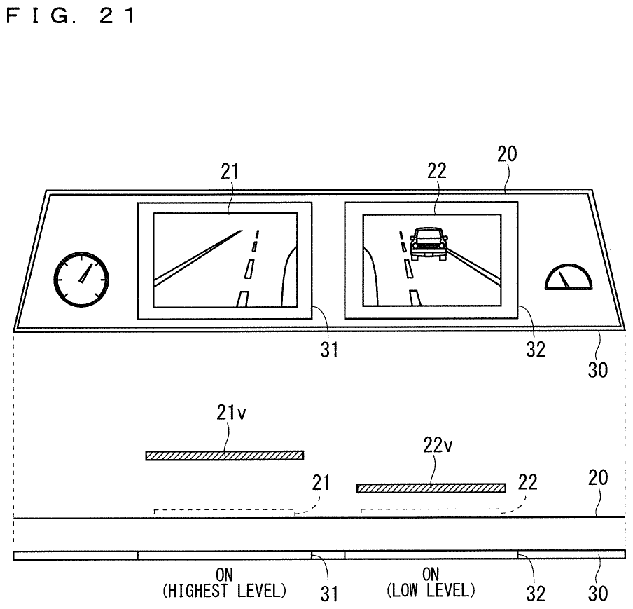

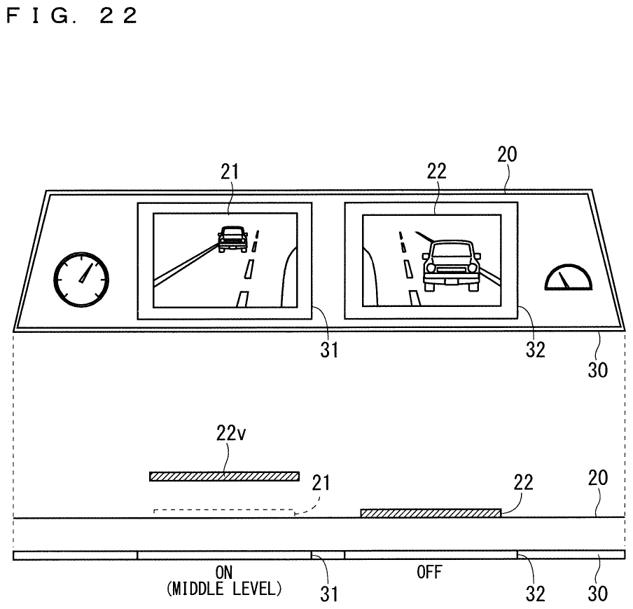

Further, when the other vehicle is captured in the right rear side image as illustrated in FIG. 20, the lens control unit 13 turns on the second liquid crystal lens 32 at the middle level to decrease the virtual image distance of the second display surface 22 shorter than that of in FIG. 19. Further, as illustrated in FIG. 21, when the distance between the other vehicle captured in the right rear side image and the subject vehicle decreases, the lens control unit 13 turns on the second liquid crystal lens 32 at the low level to decrease the virtual image distance of the second surface 22 shorter than that of in in FIG. 20. Then, when the other vehicle captured in the right rear side image approaches the subject vehicle as illustrated in FIG. 22, the lens control unit 13 turns off the second liquid crystal lens 32 to make the second display surface 22 appear at the actual position.

The lens control unit 13 also performs the same control for the virtual image distance of the first display surface 21. That is, the lens control unit 13 decreases the virtual image distance of the first display surface 21 as the distance from the subject vehicle to the other vehicle captured in the right rear side image decreases.

According to Embodiment 3, the virtual image distances of the left rear side image displayed on the first display surface 21 and the right rear side image displayed on the second display surface 22 are changed in accordance with the distance from the subject vehicle to the other vehicle captured in those images. Therefore, the driver of the subject vehicle can intuitively grasp the distance from the subject vehicle to the other vehicle from the sense of perspective of the left rear side image and the right rear side image.

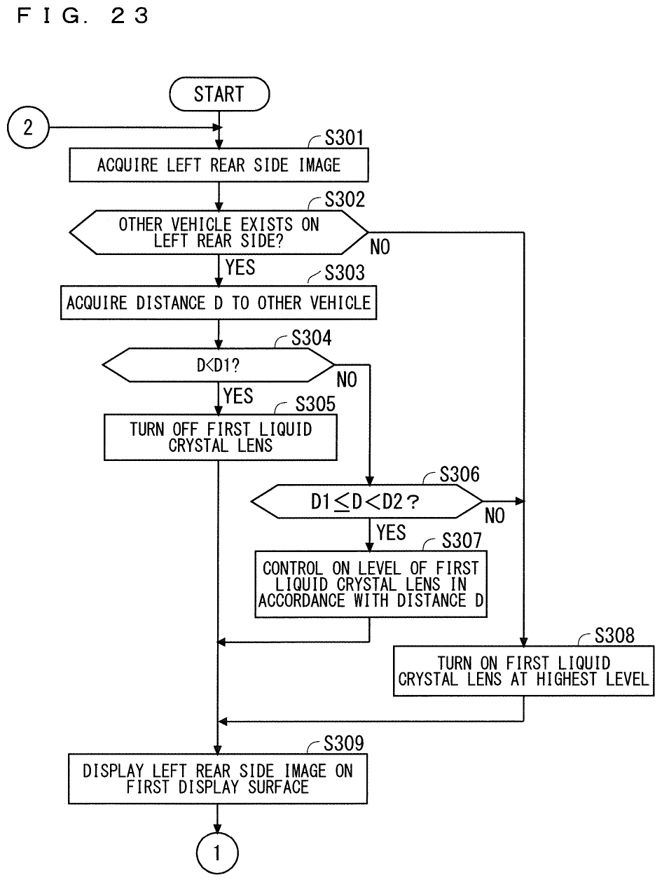

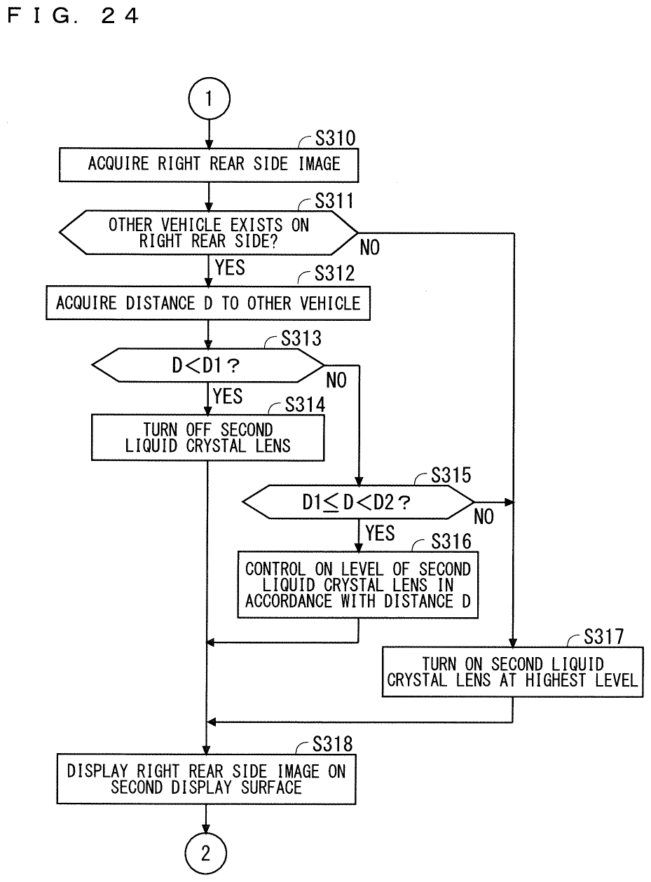

FIGS. 23 and 24 are flowcharts illustrating the operation of the display control device 10 according to Embodiment 3. Hereinafter, the operation of the display control device 10 according to Embodiment 3 will be described with reference to FIGS. 23 and 24.

When the display control device 10 is activated, the information acquisition unit 11 acquires the left rear side image from the left rear side image capturing device 44 (Step S301). Then, based on the detection result of the peripheral sensor 46, the lens control unit 13 checks whether or not the other vehicle exists on a left rear side of the subject vehicle, that is, in the range captured in the left rear side image (Step S302).

When the other vehicle does not exist on a left rear side (NO in Step S302), the lens control unit 13 turns on the first liquid crystal lens 31 at the highest level (Step S308), and the display processing unit 12 causes the first display surface 21 to display the left rear side image (Step S309). That is, the virtual image distance of the first display surface 21 is set to the maximum.

On the other hand, when the other vehicle exists on a left rear side (YES in Step S302), the information acquisition unit 11 acquires the distance D from the subject vehicle to the other vehicle from the peripheral sensor 46 (Step S303). When the distance D is smaller than a predetermined first threshold D1 (for example, 10 m) (YES in Step S304), the lens control unit 13 turns off the first liquid crystal lens 31 (Step S305), and the display processing unit 12 causes the first display surface 21 to display the left rear side image (Step S309). That is, the virtual image distance of the first display surface 21 is set to the minimum.

When the distance D is equal to or greater than the first threshold D1 (NO in Step S304) and smaller than a second threshold D2 (for example, 50 m) set in advance (YES in Step S306), the lens control unit 13 controls the on level of the first liquid crystal lens 31 in accordance with the distance D (Step S307), and the display processing unit 12 causes the first display surface 21 to display the left rear side image (Step S309). That is, the virtual image distance of the first display surface 21 changes in accordance with the change of the distance D.

When the distance D is equal to or greater than the second threshold D2 (NO in Step S306), as in the case where the other vehicle does not exists, the lens control unit 13 turns on the first liquid crystal lens 31 at the highest level (Step S308), and the display processing unit 12 causes the first display surface 21 to display the left rear side image (Step S309).

When the display of the left rear side image on the first display surface 21 (Step S309) is completed, the information acquisition unit 11 acquires the right rear side image from the right rear side image capturing device 45 (Step S310). Then, based on the detection result of the peripheral sensor 46, the lens control unit 13 checks whether or not the other vehicle exists on a right rear side of the subject vehicle, that is, in the range captured in the right rear side image (Step S311).

When the other vehicle does not exist on a left rear side (NO in Step S311), the lens control unit 13 turns on the second liquid crystal lens 32 at the highest level (Step S317), and the display processing unit 12 causes the second display surface 22 to display the right rear side image (Step S318). That is, the virtual image distance of the second display surface 22 is set to the maximum.

On the other hand, when the other vehicle exists on a right rear side (YES in Step S311), the information acquisition unit 11 acquires the distance D from the subject vehicle to the other vehicle from the peripheral sensor 46 (Step S312). When the distance D is smaller than the first threshold value D1 (YES in Step S313), the lens control unit 13 turns off the second liquid crystal lens 32 (Step S314), and the display processing unit 12 causes the second display surface 22 to display the right rear side image (Step S318). That is, the virtual image distance of the second display surface 22 is set to the minimum.

When the distance D is equal to or greater than the first threshold D1 (NO in Step S313) and smaller than the second threshold D2 (YES in Step S315), the lens control unit 13 controls the on level of the second liquid crystal lens 32 in accordance with the distance D (Step S316), and the display processing unit 12 causes the second display surface 22 to display the right rear side image (Step S318). That is, the virtual image distance of the second display surface 22 changes in accordance with the change of the distance D.

When the distance D is equal to or greater than the second threshold D2 (NO in Step S315), as in the case where the other vehicle does not exists, the lens control unit 13 turns on the second liquid crystal lens 32 at the highest level (Step S317), and the display processing unit 12 causes the second display surface 22 to display the right rear side image (Step S318)

The above flow is repeatedly executed. Accordingly, the operation of the display control device 10 described with reference to FIGS. 19 to 22 is realized.

[Modification]

In Embodiment 3, although an example is described in which the display control device 10 continuously changes the virtual image distances of the first display surface 21 and the second display surface 22 in accordance with the distance D from the subject vehicle to the other vehicle, the virtual image distances may be changed in a two-step manner. That is, one type of on level may be set for the respective first liquid crystal lens 31 and the second liquid crystal lens 32, and the display control device 10 may switch ON/OFF of the first liquid crystal lens 31 and the second liquid crystal lens 32 in accordance with the distance D from the subject vehicle to the other vehicle.

Further, in Embodiment 3, although the display control device 10 increases the virtual image distances of the first display surface 21 and the second display surface 22 as the distance D from the subject vehicle to the other vehicle increases, for example, the virtual image distances of the first display surface 21 and the second display surface 22 may also be increased when the distance D becomes very small (for example, when the distance D1 becomes 5 m or less).

The driver tends to look far ahead while the vehicle is traveling; therefore, it is conceived that they are visually recognized more readily when the virtual image distances of the first display surface 21 and the second display surface 22 are longer. Therefore, by increasing the virtual image distances of the first display surface 21 and the second display surface 22 when the distance D from the subject vehicle to the other vehicle becomes very small, the driver visually recognizes the image of the other vehicle displayed on the first display surface 21 and the second display surface 22 more readily, and an effect that facilitated recognition of approach of the other vehicle to the subject vehicle is expected.

Further, in a situation where the driver does not need to pay attention to the surroundings, such as when the subject vehicle is being automatically driven, the display controller 10 may turn off the first liquid crystal lens 31 and the second liquid crystal lens 32 regardless of the presence or absence of the other vehicle. This can contribute to reduction of power consumption of the vehicular information display system.

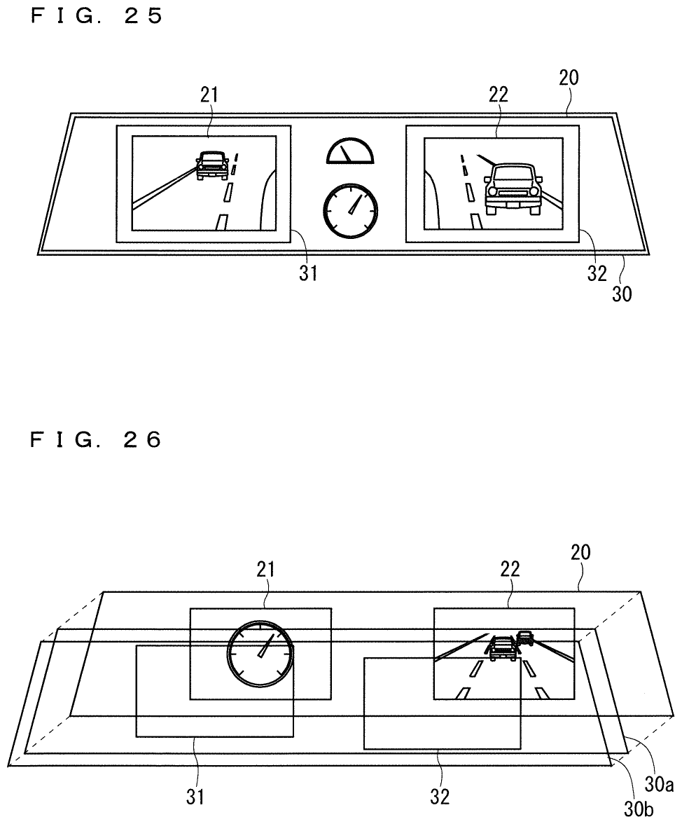

The arrangement of the first display surface 21 and the second display surface 22 in the electronic mirror system is not limited to the examples illustrated in FIGS. 19 to 22. For example, as illustrated in FIG. 25, meters may be arranged between the first display surface 21 and the second display surface 22 on the display plate 20 of the instrument panel. Also, the first display surface 21 and the second display surface 22 may be arranged at a place different from the instrument panel as long as they are readily visible to the driver.

The first display surface 21 and the second display surface 22 are not necessarily to be separate image display devices, for example, the left half area of one horizontally long screen may be the first display surface 21, and the right half area may be the second display surface 22. Furthermore, the images of the meters may be displayed at the center of one horizontally long screen to realize the layout illustrated in FIG. 25.

In Embodiment 3, although the configuration in which the distance from the subject vehicle to the other vehicle captured in the left rear side image or the right rear side image is measured by the peripheral sensor 46 is adopted, the distance to the other vehicle may be obtained by other methods. For example, the display control device 10 may analyze the left rear side image and the right rear side image, and from the analysis result, the distance from the subject vehicle to the other vehicle captured in the left rear side image or the right rear side image may be calculated.

### Embodiment 4

In Embodiment 1, the first liquid crystal lens 31 and the second liquid crystal lens 32 are provided on one transparent cover arranged in front of the display plate 20 of the instrument panel. In Embodiment 4, the liquid crystal lens 31 and the second liquid crystal lens 32 are arranged on different transparent covers, respectively.

That is, in Embodiment 4, as illustrated in FIG. 26, a transparent cover 30a including the first liquid crystal lens 31 and a transparent cover 30b including the second liquid crystal lens 32 are arranged so as to overlap each other, in front of the display plate 20 including the first display surface 21 and the second display surface 22. Therefore, a distance between the first display surface 21 and the first liquid crystal lens 31 and a distance between the second display surface 22 and the second liquid crystal lens 32 have values which are different from each other.

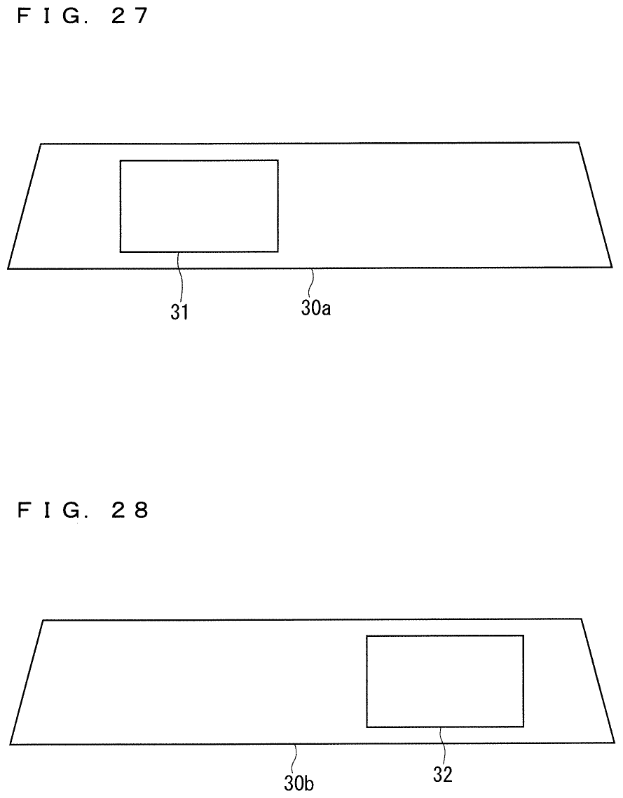

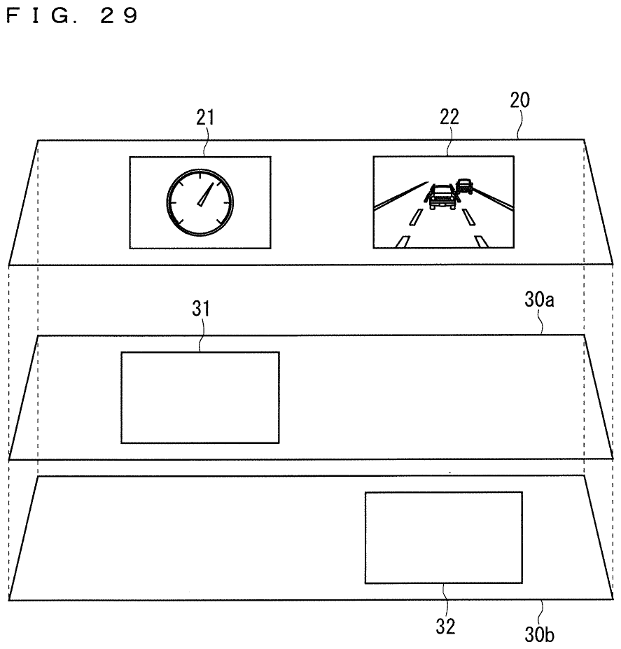

FIGS. 27 and 28 illustrate configurations of the respective transparent cover 30a and the transparent cover 30b. The first liquid crystal lens 31 of the transparent cover 30a is arranged at a position overlapping the first display surface 21 when the transparent cover 30a is installed in front of the display plate 20. The second liquid crystal lens 32 of the transparent cover 30b is arranged at a position overlapping the second display surface 22 when the transparent cover 30b is installed in front of the display plate 20. In the following, the display plate 20, the transparent cover 30a and the transparent cover 30b arranged as shown in FIG. 26 are illustrated as shown in FIG. 29.

In Embodiment 4, the transparent cover 30a is installed on the back side (the side close to the display plate 20) when viewed from the driver, and the transparent cover 30b is installed on the front side (the side close to the driver) when viewed from the driver. That is, the distance from the display plate 20 to the transparent cover 30a is shorter than the distance from the display plate 20 to the transparent cover 30b. Therefore, a distance between the first display surface 21 and the first liquid crystal lens 31 is smaller than a distance between the second display surface 22 and the second liquid crystal lens 32.

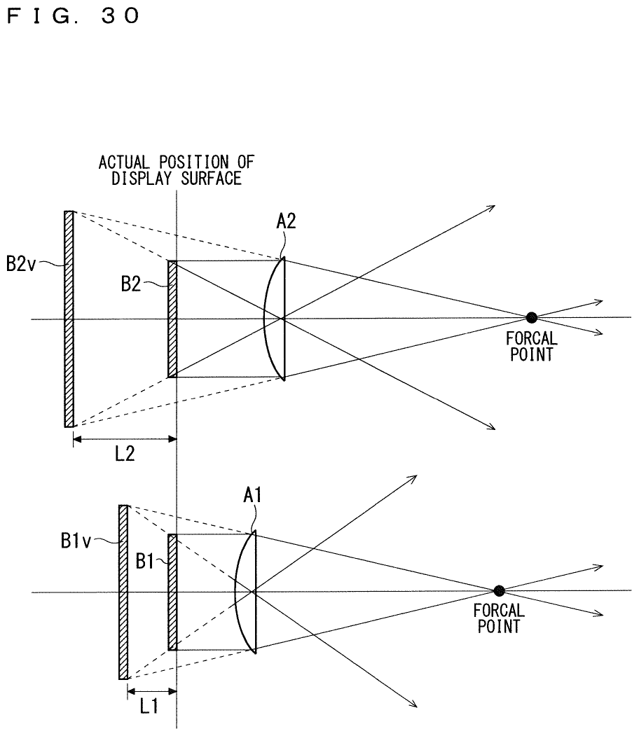

Here, a relationship between a distance from a display surface to a liquid crystal lens and a virtual image distance of the display surface will be described with reference to FIG. 30. In FIG. 30, two display surfaces B1 and B2 are present on the same plane, a liquid crystal lens A1 is arranged in front of the display surface B1, and a liquid crystal lens A2 is arranged in front of the display surface B2. Although the liquid crystal lenses A1 and A2 have the same optical characteristics, the distance from the display surface B1 to the liquid crystal lens A1 is shorter than the distance from the display surface B2 to the liquid crystal lens A2. In this case, as can be seen from FIG. 30, the virtual image B2v of the display surface B2 seen through the liquid crystal lens A2 appears farther than the virtual image B1v of the display surface B1 seen through the liquid crystal lens A1. That is, the virtual image distance of the display surface B2 is longer than the virtual image distance of the display surface B1. As can be seen from this example, if the optical characteristics of the liquid crystal lenses are fixed, the virtual image distance of the display surface is increased as the distance from the display surface to the liquid crystal lens increases.

In Embodiment 4, the optical characteristics of the first liquid crystal lens 31 and the second liquid crystal lens 32 are assumed to be the same. Therefore, the virtual image distance of the first display surface 21 is shorter than the virtual image distance of the second display surface 22.

In Embodiment 1, as illustrated in FIGS. 6 and 9, a difference is provided between the virtual image distance of the first display surface 21 and the virtual image distance of the second display surface 22 by making the optical characteristics of the first display surface 21 different from the optical characteristics of the second display surface 22. On the other hand, in Embodiment 4, a difference is provided between the virtual image distance of the first display surface 21 and the virtual image distance of the second display surface 22 by using the first liquid crystal lens 31 and the second liquid crystal lens 32 having the same optical characteristics, thereby the same effect as that of Embodiment 1 can be obtained.

According to Embodiment 4, although there is a disadvantage that two transparent covers are required, the development cost of the liquid crystal lens can be suppressed because the same optical characteristics are applicable to the first liquid crystal lens 31 and the second liquid crystal lens 32.

[Modification]

In Embodiment 4, the first liquid crystal lens 31 and the second liquid crystal lens 32 are arranged on different planes; therefore, the first liquid crystal lens 31 and the second liquid crystal lens 32 can be arranged so that at least portions thereof can be overlapped with each other.

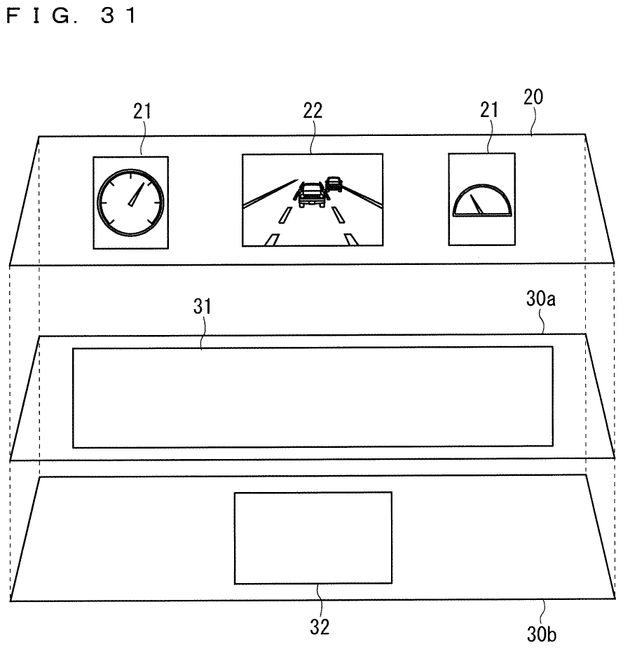

For example, as illustrated in FIG. 31, the second liquid crystal lens 32 may be covered by the first liquid crystal lens 31 by arranging the first liquid crystal lens 31 so as to overlap with both the first display surface 21 and the second display surface 22. In this case, when both the first liquid crystal lens 31 and the second liquid crystal lens 32 are turned on, the virtual image distance of the second display surface 22 becomes longer than when only the second liquid crystal lens 32 is turned on. Therefore, four types of virtual image distances of the second display surface 22 can be realized by combinations of turning on and off of the first liquid crystal lens 31 and the second liquid crystal lens 32.

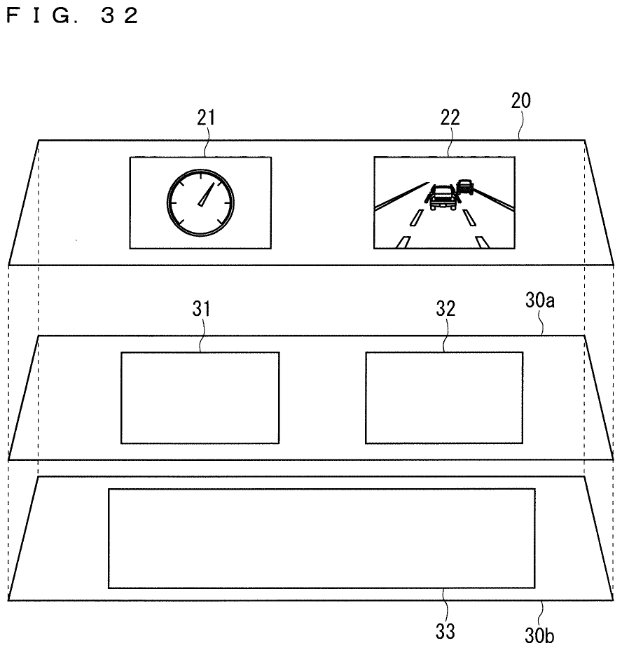

Further, as illustrated in FIG. 32, the first liquid crystal lens 31 and the second liquid crystal lens 32 may be provided on the same transparent cover 30a, and a third liquid crystal lens 33 may be provided on the transparent cover 30b so that at least portions of the third liquid crystal lens 33 overlap with the first liquid crystal lens 31 and the second liquid crystal lens 32. In this case, the lens control unit 13 of the display control device 10 controls the first liquid crystal lens 31, the second liquid crystal lens 32, and the third liquid crystal lens 33 to control the virtual image distance of the first display surface 21 and the virtual image distance of the second display surface 22. Therefore, four types of virtual image distances for the respective first display surface 21 and the second display surface 22 can be realized by combinations of the first display surface 21, the second display surface 22, and turning on and off of the third liquid crystal lens 33.

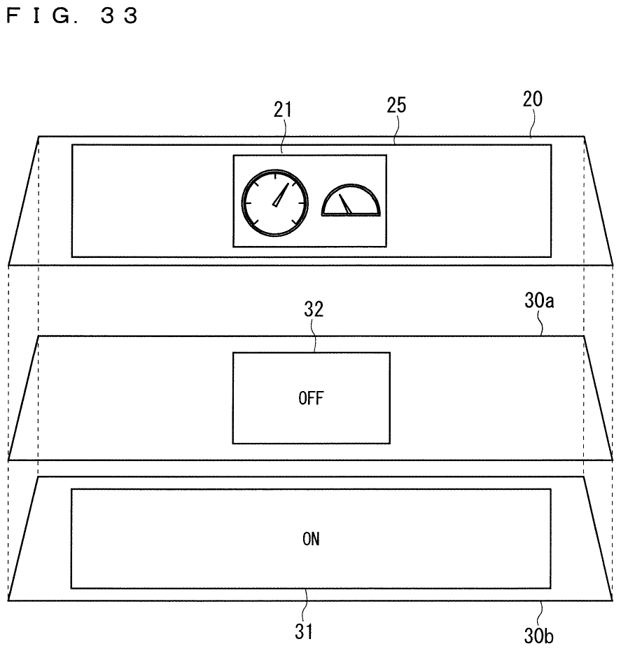

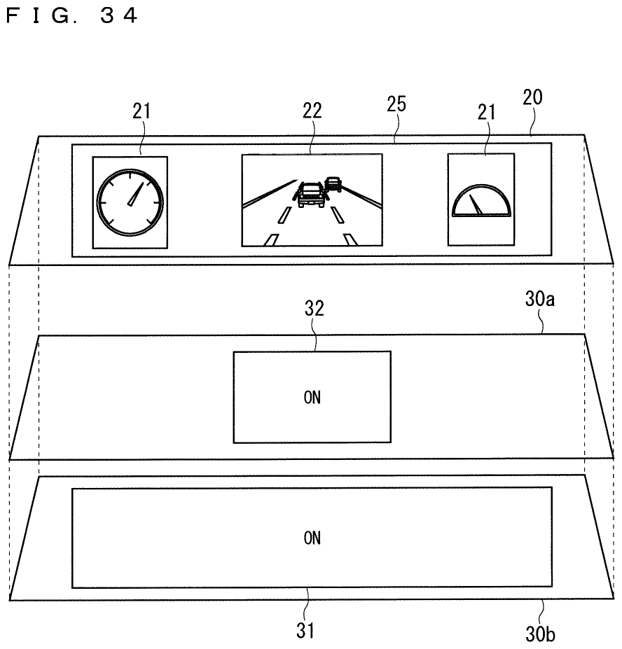

Further, the display plate 20 of the instrument panel may have a horizontally long screen 25 that is capable of switching between a first display mode in which only the first display surface 21 is arranged on the screen 25 as illustrated in FIG. 33 and a second display mode in which the first display surface 21 and the second display surface 22 are arranged on the screen 25 as illustrated in FIG. 34. The Embodiment 4 is also applicable to an instrument panel having such a display plate 20.

As illustrated in FIGS. 33 and 34, the first liquid crystal lens 31 is provided on the transparent cover 30a installed on the back side when viewed from the driver and is arranged so as to cover both the first display surface 21 in the first display mode and the first display surface 21 in the second display mode. Also, the second liquid crystal lens 32 is provided on the transparent cover 30b installed on the front side when viewed from the driver and is arranged so as to cover the second display surface 22 in the second display mode. Then, the first liquid crystal lens 31 is turned on in the first display mode, and both the first liquid crystal lens 31 and the second liquid crystal lens 32 are turned on in the second display mode. Therefore, in the second display mode, the virtual image distances of the meter images displayed on the first display surface 21 are shorter than the virtual image distance of the rear image displayed on the second display surface 22. According to Modification, even when the position of the first display surface 21 changes between the first display mode and the second display mode, a difference can be provided between the virtual image distance of the first display surface 21 and the virtual image distance of the second liquid crystal lens 32.

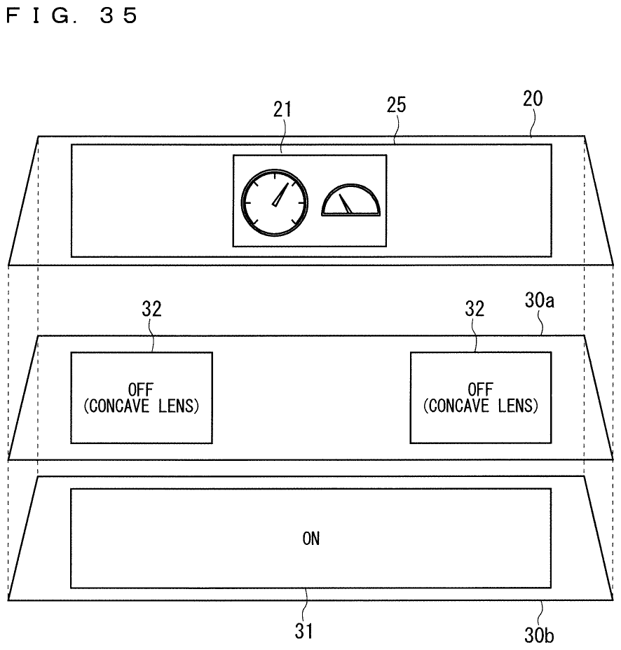

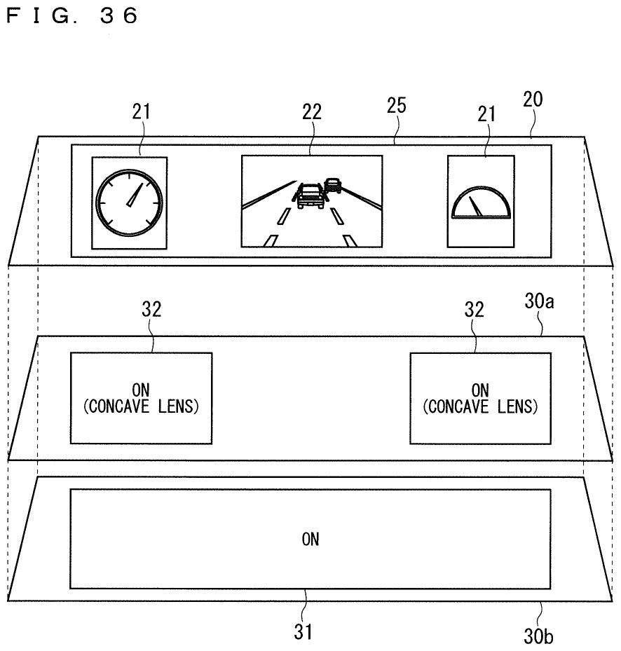

The combination of the liquid crystal lenses overlapping with each other may be a combination of a convex lens and a concave lens. FIGS. 35 and 36 are examples in which concave lenses are used as the second liquid crystal lenses 32 to achieve the same visual effect as in FIGS. 33 and 34. In FIGS. 35 and 36, the first liquid crystal lens 31 (convex lens) is provided so as to cover both the first display surface 21 in the first display mode and the first display surface 21 in the second display mode. The second liquid crystal lens 32 (concave lens) is provided so as to cover the position of the first display surface 21 in the second display mode. Then, the first liquid crystal lens 31 is turned on in the first display mode, and both the first liquid crystal lens 31 and the second liquid crystal lens 32 are turned on in the second display mode. The concave lens acts to decrease the virtual image distance; therefore, in the second display mode, the virtual image distances of the meter images displayed on the first display surface 21 are shorter than the virtual image distance of the rear image displayed on the second display surface 22.

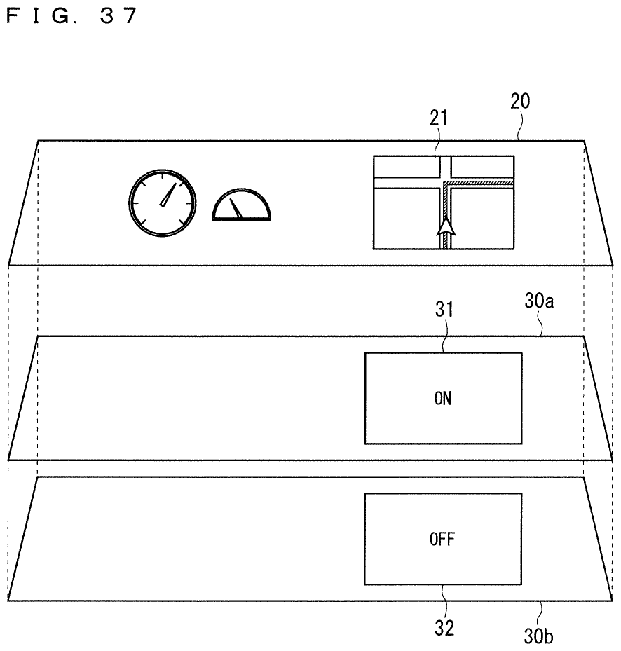

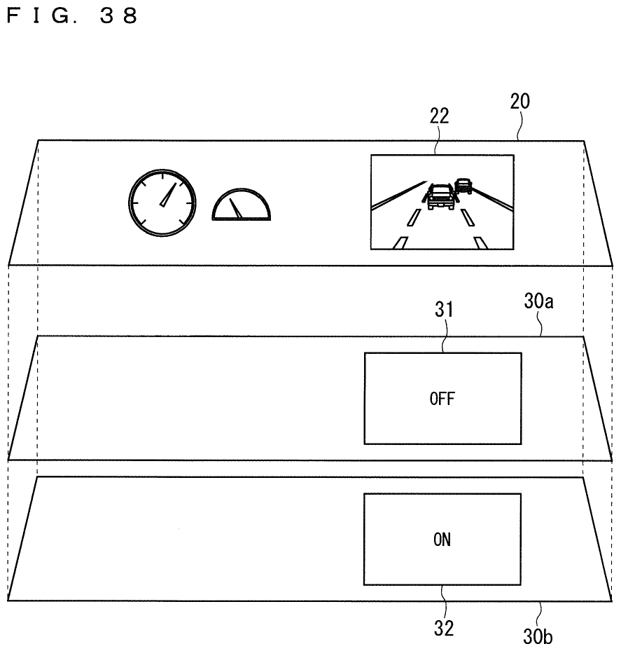

In FIGS. 33 to 36, although an example in which the position of the display surface changes for each display mode is illustrated, the display surface arranged at the same position may be switched for each display mode. For example, in a fixed position of the display plate 20 of the instrument panel, in the first display mode, the first display surface 21 on which the navigation screen is displayed as illustrated in FIG. 37 may be arranged, and in the second display mode, the second display surface 22 on which the rear image is displayed as illustrated in FIG. 38 may be arranged. That is, in this example, one of the first display surface 21 and the second display surface 22 is displayed at the same position on the display plate 20 one by one.

In the example of FIGS. 37 and 38, the first liquid crystal lens 31 and the second liquid crystal lens 32 are provided to cover the positions where the first display surface 21 and the second display surface 22 are arranged, respectively, so as to overlap with each other. Further, the distance from the first display surface 21 to the first liquid crystal lens 31 is shorter than the distance from the second display surface 22 to the second liquid crystal lens 32. Then, the first liquid crystal lens 31 is turned on in the first display mode, and the second liquid crystal lens 32 are turned on in the second display mode. As a result, the virtual image distance of the navigation screen in the first display mode is shorter than the virtual image distance of the rear image in the second display mode.

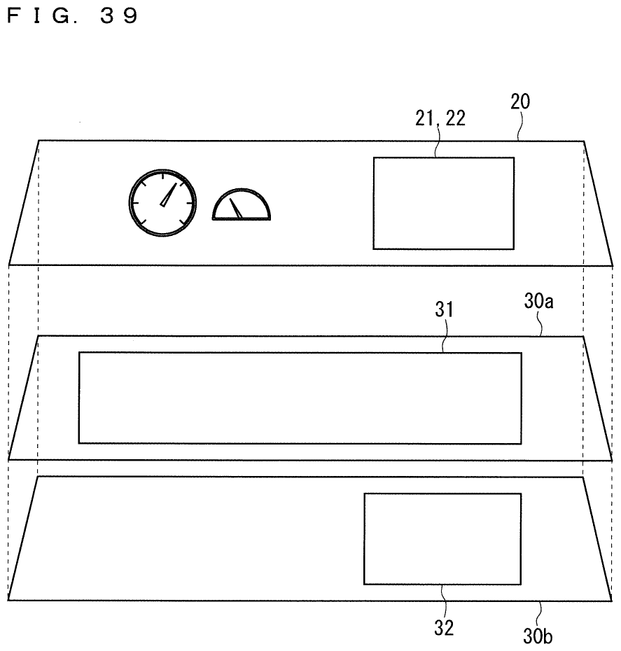

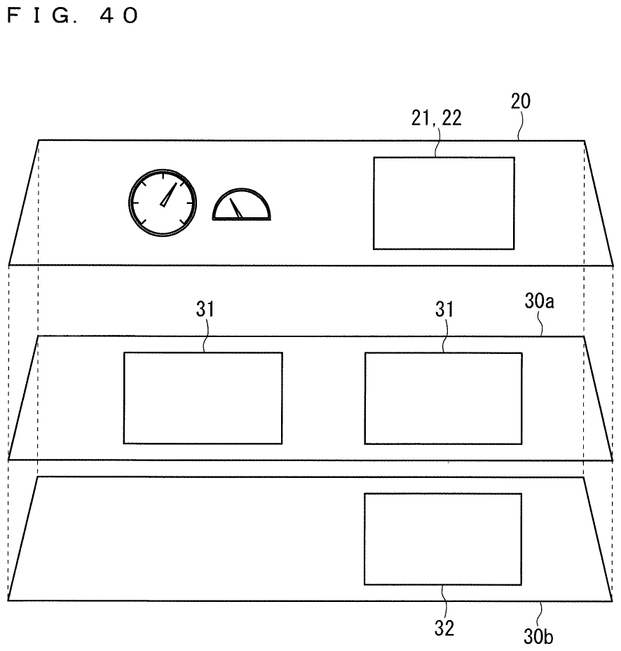

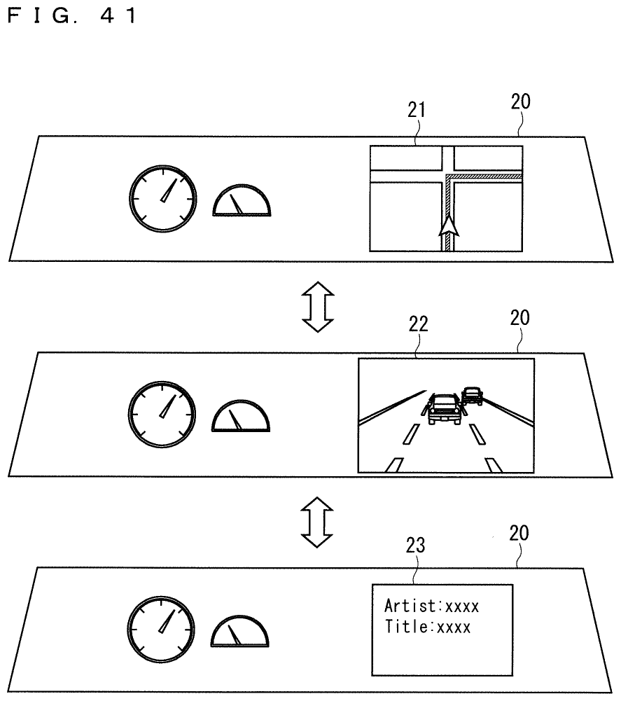

In FIGS. 37 and 38, although an example in which the meter portion of the display plate 20 of the instrument panel is not covered with the first liquid crystal lens 31 and the second liquid crystal lens 32 is illustrated, for example, as illustrated in FIGS. 39 and 40, the meter portion may be covered with the first liquid crystal lens 31 (or the second liquid crystal lens 32).

Further, the number of display modes of the display plate 20 of the instrument panel is not limited to two, and there may be three or more. For example, as illustrated in FIG. 41, in a fixed position of the display plate 20, in the first display mode, the first display surface 21 on which the navigation screen is displayed may be arranged, in the second display mode, the second display surface 22 on which the rear image is displayed may be arranged, and in the third display mode, a third display surface 23 on which an entertainment screen is displayed may be arranged.

In the example of FIG. 41, the first liquid crystal lens 31 is turned on in the first display mode, the second liquid crystal lens 32 is turned on in the second display mode, and the first liquid crystal lens 31 and the second liquid crystal lens 32 are turned off in the first display mode. As a result, the virtual image distance of the entertainment screen in the third display mode is shorter than the virtual image distance of the navigation screen in the first display mode, and also the virtual image distance of the navigation screen in the first display mode is shorter than the virtual image distance of the rear image in the second display mode.

Further, the number of liquid crystal lenses to be overlapped is not limited to two, and three or more liquid crystal lenses may be arranged so as to overlap with each other. In addition, a plurality of liquid crystal lenses that overlap with each other may be built in one thick transparent cover.

In Embodiment 4, although an example in which the optical characteristics of the first liquid crystal lens 31 and the second liquid crystal lens 32 are the same is illustrated, the characteristics may differ from one another.

### Embodiment 5

In the above Embodiments, the first liquid crystal lens 31 is installed in parallel with the first display surface 21, and the second liquid crystal lens 32 is installed in parallel with the second display surface 22. Therefore, the apparent distance (virtual image distance) of the virtual image of the first display surface 21 projected by the first liquid crystal lens 31 is uniform within the first display surface 21, and the apparent distance (virtual image distance) of the virtual image of the second display surface 22 projected by the first liquid crystal lens 31 is uniform within the second display surface 22.

On the other hand, in Embodiment 5, the first liquid crystal lens 31 or the second liquid crystal lens 32 is arranged at an angle (non-parallel) with respect to the first display surface 21 or the second display surface 22. Accordingly, at least one of the virtual image distance of the first display surface 21 and the virtual image distance of the second display surface 22 differs depending on the position within the display surface.

As described with reference to FIG. 30, as the distance from the display surface to the liquid crystal lens increases, the virtual image distance of the display surface increases. Therefore, when the liquid crystal lens is arranged in an inclined manner with respect to the display surface, the virtual image distance in the portion far from the liquid crystal lens is longer than the virtual image distance in the portion close to the liquid crystal lens, and the virtual image of the display surface appears inclined.

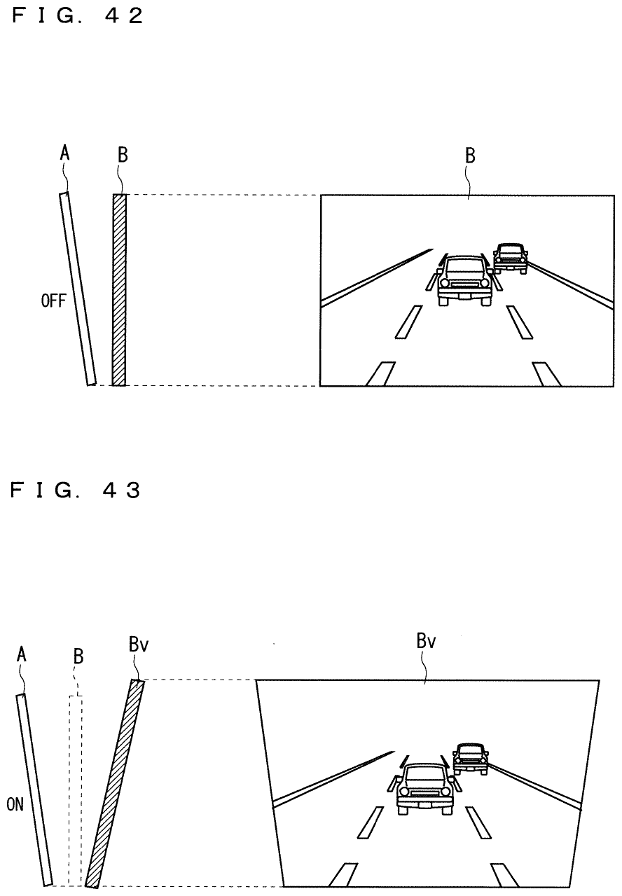

For example, in the case where the liquid crystal lens A is arranged in an inclined manner such that a distance between the liquid crystal lens A and the display surface B becomes wider toward the upper side of the display surface B, to the driver, the display surface B appears as it is as illustrated in FIG. 42 when the liquid crystal lens A is off, and the virtual image By of the display surface B appears as illustrated in FIG. 43 when the liquid crystal lens A is on. At this time, the apparent distance (virtual image distance) from the driver to the virtual image By of the display surface B becomes longer toward the upper side of the virtual image By.

In the case where the rear image is displayed on the display surface B as in the example of FIGS. 42 and 43, the distant landscape is reflected in the upper portion of the rear image, and thus the virtual image distance becomes longer toward the upper side of the display surface B. As a result, the driver can intuitively grasp the sense of perspective of the landscape reflected in the rear image.

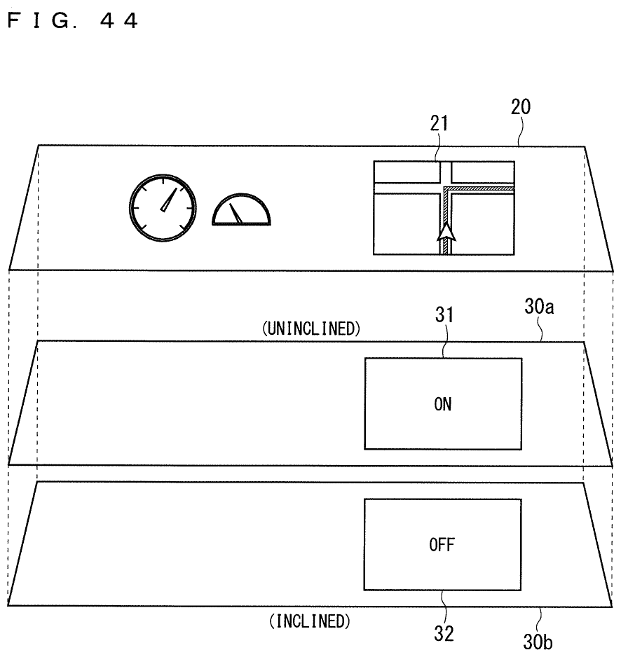

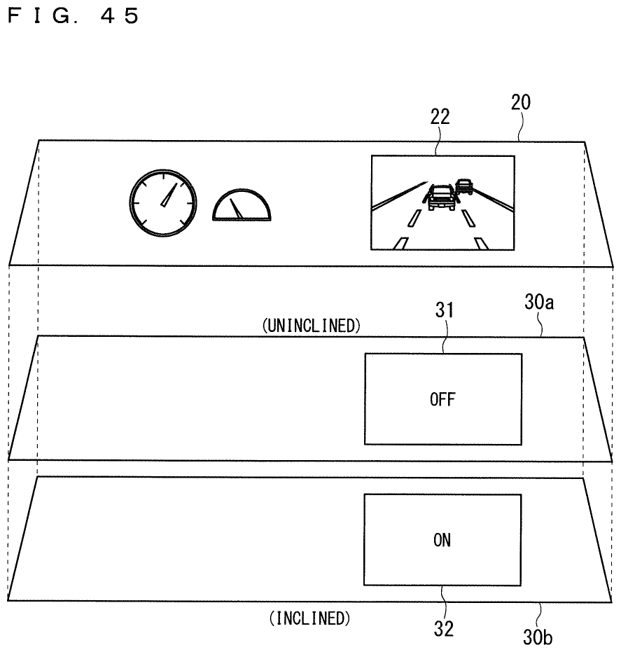

For example, a case is assumed in which, in a fixed position of the display plate 20 of the instrument panel, in the first display mode, the first display surface 21 on which the navigation screen is displayed as illustrated in FIG. 44 is arranged, and in the second display mode, the second display surface 22 on which the rear image is displayed as illustrated in FIG. 45 is arranged. In this case, the first liquid crystal lens 31 is installed in parallel with the display plate 20, and the second liquid crystal lens 32 is installed in an inclined manner with respect to the display plate 20. The display control device 10 turns on the first liquid crystal lens 31 as illustrated in FIG. 44 in the first display mode, and turns on the second liquid crystal lens 32 as illustrated in FIG. 45 in the second display mode. Accordingly, the virtual image distance of the rear image displayed in the second display mode can be made longer than the virtual image distance of the navigation screen displayed in the first display mode, and the virtual image distance can be made longer toward the upper side of the rear image.

[Modification 1]

In FIGS. 44 and 45, although an example is illustrated in which the meter portion of the display plate 20 of the instrument panel is not covered with the first liquid crystal lens 31 and the second liquid crystal lens 32, the meter portion may be covered with the first liquid crystal lens 31 (or the second liquid crystal lens 32) similar to FIGS. 39 and 40.

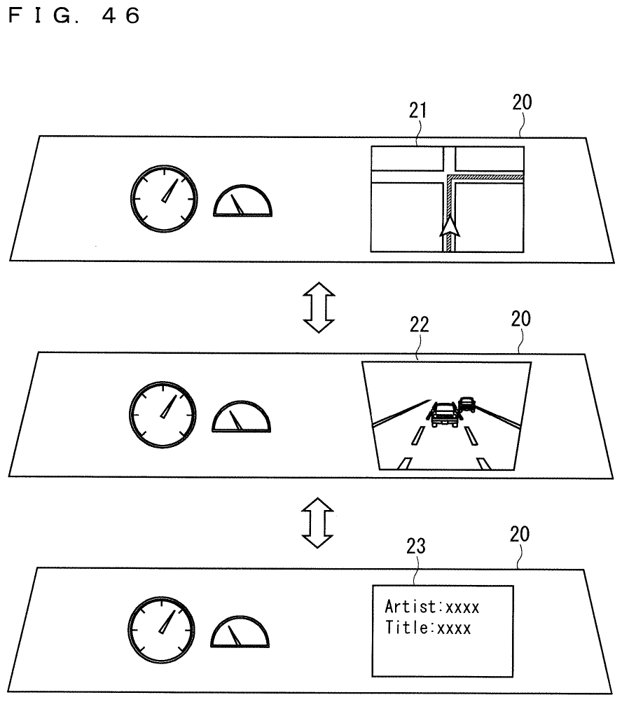

Further, the number of the display modes of the display plate 20 of the instrument panel is not limited to two, and there may be three or more. For example, as illustrated in FIG. 46, in a fixed position of the display plate 20 of the instrument panel, in the first display mode, the first display surface 21 on which the navigation screen is displayed may be arranged, in the second display mode, the second display surface 22 on which the rear image is displayed may be arranged, and in the third display mode, the third display surface 23 on which the entertainment screen is displayed may be arranged.

In the example of FIG. 46, the first liquid crystal lens 31 is turned on in the first display mode, the second liquid crystal lens 32 is turned on in the second display mode, and the first liquid crystal lens 31 and the second liquid crystal lens 32 are turned off in the first display mode. As a result, the virtual image distance of the entertainment screen in the third display mode is shorter than the virtual image distance of the navigation screen in the first display mode, the virtual image distance of the navigation screen in the first display mode is shorter than the virtual image distance of the rear image in the second display mode.

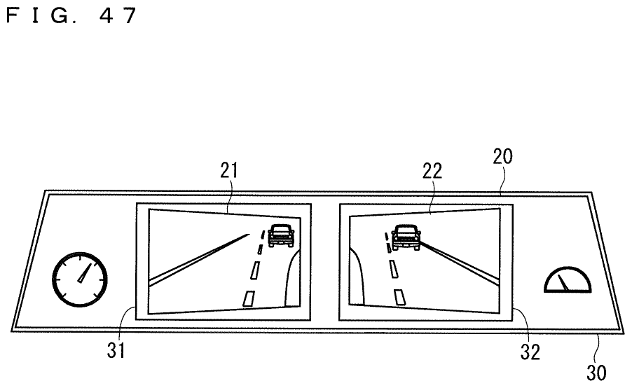

In Embodiment 5, although only one of the first liquid crystal lens 31 and the second liquid crystal lens 32 is inclined with respect to the display surface, both lenses may be inclined. For example, as illustrated in FIG. 47, in the electronic mirror system in which the left rear side image is displayed on the first display surface 21 and the right rear side image is displayed on the second display surface 22, the first liquid crystal lens 31 and the second liquid crystal lens 32 may be inclined symmetrically so that the virtual image distances become longer outside the first display surface 21 and the second display surface 22. The distant landscape is reflected in the outer portion (left end portion) of the left rear side image and the outer portion (right end portion) of the right rear side image; therefore, the virtual image distances of those portions become long. As a result, the driver can intuitively grasp the sense of perspective of the landscape reflected in the left rear side image and the right rear side image.

In the example of FIG. 47, the first liquid crystal lens 31 and the second liquid crystal lens 32 do not need to be overlapped with each other, and therefore both need only be formed on one transparent cover 30. However, the transparent cover 30 is formed in a bent shape or a curved shape so that the first liquid crystal lens 31 and the second liquid crystal lens 32 are inclined symmetrically with respect to the first display surface 21 and the second display surface 22.

Further, in Embodiment 5, the liquid crystal lens is installed in an inclined manner with respect to the display surface so that the virtual image distance of the display surface varies depending on the position. However, for example, with a liquid crystal lens having different optical characteristics depending on the position is used, the virtual image distance of the display surface can be varied depending on the position without inclining the liquid crystal lens with respect to the display surface.

It should be noted that Embodiments of the present invention can be arbitrarily combined and can be appropriately modified or omitted without departing from the scope of the invention.

While the invention has been described in detail, the forgoing description is in all aspects illustrative and not restrictive. It is understood that numerous other modifications and variations can be devised without departing from the scope of the invention.

### EXPLANATION OF REFERENCE SIGNS

10 display control device, 11 information acquisition unit, 12 display processing unit, 13 lens control unit, 20 display plate, 21 first display surface, 22 second display surface, 23 third display surface, 25 screen, 30, 30a 30b transparent cover, 31 first liquid crystal lens, 32 second liquid crystal lens, 33 third liquid crystal lens, 41 in-vehicle LAN, 42 image capturing device, 43 in-vehicle information system, 44 left rear side image capturing device, 45 right rear side image capturing device, 46 peripheral sensor, 50 processing circuit, 51 processor, 52 memory, 60 housing.

1. A vehicular display control device comprising:
a processor to execute a program; and
a memory to store the program which, when executed by the processor, performs processes of,
acquiring first information and second information;
causing a first display surface provided in a subject vehicle to display the first information, and causing a second display surface provided in the subject vehicle to display the second information; and
setting a virtual image distance of the first display surface by controlling a first liquid crystal lens arranged in front of the first display surface based on a type of the first information, and setting a virtual image distance of the second display surface by controlling a second liquid crystal lens arranged in front of the second display surface based on a type of the second information.

2. The vehicular display control device according to claim 1, wherein
the processor further changes at least one of the virtual image distance of the first display surface or the second display surface in accordance with information indicating a traveling state of the subject vehicle.

3. The vehicular display control device according to claim 2, wherein
the information indicating the traveling state of the subject vehicle is information on a traveling speed of the subject vehicle or a classification of a road on which the subject vehicle is traveling.

4. The vehicular display control device according to claim 1, wherein
the first display surface and the second display surface are areas different from each other on one screen.

5. The vehicular display control device according to claim 1, wherein
the first display surface and the second display surface are arranged in an instrument panel of the subject vehicle.

6. The vehicular display control device according to claim 1, wherein
the processor acquires the first information and the second information from any of an in-vehicle LAN, an information system, a traveling control system, an indicating lamp, a warning lamp, a surrounding state detection device, or an in-vehicle image capturing device.

7. The vehicular display control device according to claim 1, wherein
a distance between the first display surface and the first liquid crystal lens and a distance between the second display surface and the second liquid crystal lens are different from each other.

8. The vehicular display control device according to claim 7, wherein
the first liquid crystal lens and the second liquid crystal lens are overlapped with each other at least in portions thereof.

9. The vehicular display control device according to claim 1, wherein
the processor controls the virtual image distances of the first display surface and the second display surface by controlling a third liquid crystal lens arranged to overlap with the first liquid crystal lens and the second liquid crystal lens at least in portions thereof.

10. The vehicular display control device according to claim 1, wherein
the first information is a first image for an electronic mirror of the subject vehicle, and the second information is a second image for the electronic mirror of the subject vehicle.

11. The vehicular display control device according to claim 10, wherein
the processor controls the virtual image distance of the first display surface based on a distance from the subject vehicle to an object captured in the first image, and controls the virtual image distance of the second display surface based on a distance from the subject vehicle to an object captured in the second image.

12. The vehicular display control device according to claim 1, wherein
at least one of the virtual image distance of the first display surface, which is projected by the first liquid crystal lens or the virtual image distance of the second display surface, which is projected by the second liquid crystal lens varies depending on a position within the first display surface or the second display surface.

13. The vehicular display control device according to claim 12, wherein
at least one of a distance between the first liquid crystal lens and the first display surface and a distance between the second liquid crystal lens and the second display surface varies depending on a position within the first display surface or the second display surface.

14. The vehicular display control device according to claim 12, wherein
at least one of optical characteristics of the first liquid crystal lens and optical characteristics of the second liquid crystal lens vary depending on a position within the first display surface or the second display surface.

15. The vehicular display control device according to claim 12, wherein
the first information is a first image for an electronic mirror of the subject vehicle, and the second information is a second image for the electronic mirror of the subject vehicle, and
the virtual image distance of the first display surface, which is projected by the first liquid crystal lens and the virtual image distance of the second display surface, which is projected by the second liquid crystal lens are symmetric.

16. The vehicular display control device according to claim 13, wherein
the first display surface and the second display surface are arranged in an instrument panel of the subject vehicle.

17. The vehicular display control device according to claim 1, wherein,
when information indicating occurrence of a specific event is included in the first information or the second information, the processor changes the virtual image distance of the first display surface or the second display surface on which the information corresponding to the specific event is displayed.

18. The vehicular display control device according to claim 1, wherein
the first display surface and the second display surface are displayed at a same position one by one, and
the first liquid crystal lens and the second liquid crystal lens are overlapped with each other.

19. The vehicular display control device according to claim 1, further comprising
a display device including the first display surface and the second display surface.

20. A vehicular display control method comprising:
acquiring first information and second information;
causing a first display surface provided in a subject vehicle to display the first information, and causing a second display surface provided in the subject vehicle to display the second information; and
setting a virtual image distance of the first display surface by controlling a first liquid crystal lens arranged in front of the first display surface based on a type of the first information, and setting a virtual image distance of the second display surface by controlling a second liquid crystal lens arranged in front of the second display surface based on a type of the second information.
